(19) United States
(12) Patent Application Publication
(10) Pub. No.: US 2023/0299260 A1
(43) Pub. Date: Sep. 21, 2023

(54) MANUFACTURING DEVICE FOR ELECTRODE FOR A LITHIUM-ION BATTERY AND METHOD FOR MANUFACTURING ELECTRODE FOR A LITHIUM-ION BATTERY

(71) Applicant: APB CORPORATION, Tokyo (JP)

(72) Inventors: Yuichiro YOKOYAMA, Kyoto (JP); Takahiro IMAISHI, Kyoto (JP); Masaaki MORIZANE, Kyoto (JP); Shinya KOBAYASHI, Kyoto (JP); Yusuke NAKASHIMA, Kyoto (JP); Hideaki HORIE, Tokyo (JP)

(73) Assignee: APB CORPORATION, Tokyo (JP)

(21) Appl. No.: 18/015,796

(22) PCT Filed: Jul. 14, 2021
(86) PCT No.: PCT/JP2021/026517

§ 371 Date: Jan. 12, 2023

(30) Foreign Application Priority Data
Jul. 14, 2020 (JP) 2020-120772
Jul. 14, 2020 (JP) 2020-120773

(51) Int. Cl. H01M 4/04

(52) U.S. Cl. CPC H01M 4/0435

(57) ABSTRACT

A manufacturing device for an electrode of a lithium-ion battery, comprising: a placing section for placing an electrode material for a lithium-ion battery on a substrate, the electrode material for a lithium-ion battery consisting of an electrode composition including electrode active material particles and a frame-like member placed annularly so as to surround the electrode composition; a pressure reduction packaging section for reducing pressure and packaging the electrode material for a lithium-ion battery together with the substrate so as to fix the electrode composition by the frame-like member and a packaging material; and a pressure molding section for roll-pressing the electrode composition fixed by the frame-like member and the packaging material

### TECHNICAL FIELD

The present invention relates to a manufacturing device for an electrode for a lithium-ion battery and a method for manufacturing an electrode for a lithium-ion battery.

### BACKGROUND ART

In recent years, the reduction of carbon dioxide emissions has become an ardent desire for environmental protection. In the automotive industry, there are high expectations for reducing carbon dioxide emissions through the introduction of electric vehicles (EV) and hybrid electric vehicles (HEV), and the development of rechargeable batteries for motor drives, which hold the key to their commercialization, is being pursued intensively. As a secondary battery, a lithium-ion battery (also referred to a a lithium-ion rechargeable battery), which can achieve high energy density and high power density, are attracting attention.

Manufacturing methods for such an lithium-ion battery generally includes a method in which a slurry of an electrode active material mixed with a binder and solvent is applied onto a substrate and compressed after the solvent is removed. However, there has been a problem in which such a method requires a lot of time and energy for removing the solvent. Further, since a solvent is generally a non-aqueous electrolyte, it has been difficult to suppress production costs because a solvent recovery mechanism is required from the viewpoint of preventing air pollution.

On the other hand, as a manufacturing method for a lithium-ion battery, a method of pressure-molding an electrode active material using a roll press has been considered (e.g., Patent Literatures 1 and 2). The pressure-molding of the electrode active material using a roll press can suppress the time and energy required for removing the solvent.

Further, Patent Literature 1 discloses a manufacturing method for an electrode layer in which electrode material powder containing an electrode active material and a binding agent to a region surrounded by a pair of rolls and an end rectifying member, and the supplied electrode material powder is pressure-molded in the region surrounded by the pair of rolls and the end rectifying member.

For example, Patent Literature 2 discloses a manufacturing method of an electrode comprising the steps of: forming an electrode composite layer by supplying a granulated material containing an electrode active material, a binder, and water between a pair of rolls to pressure-mold the granulated material with the pair of rolls; and placing the electrode composite layer on an electrode current collector.

### CITATION LIST

### Patent Literature

PTL 1: Japanese Patent No. 5772429
PTL 2: Japanese Unexamined Patent Application Publication No. 2018-85182

### SUMMARY OF INVENTION

However, since the method described in Patent Literature 1 can produce only an electrode layer that is continuous in the MD direction, the electrode layer has to be further processed for using as an electrode for a lithium-ion battery. This process was prone to defects such as cracking and chipping in the electrode layer.

Further, in both of the methods described in Patent Literatures 1 and 2, since the electrode active material in powder form is applied to the roll press, air is caught and compressed by the roll together with the electrode active material powder, causing the electrode shape to collapse due to the compressed air blowing out.

This problem is significantly noticeable when the roll rotation speed is increased, making it difficult to increase production speed.

The purpose of the present invention is to provide a manufacturing method for an electrode for a lithium-ion battery and a manufacturing device thereof, which suppress the occurrence of cracking and chipping in the electrode layer and also make molding defects unlikely to occur even when the roll rotation speed is increased.

### MEANS FOR SOLVING THE PROBLEMS

The present invention relates to a manufacturing device for an electrode of a lithium-ion battery, comprising: a placing section for placing an electrode material for a lithium-ion battery on a substrate, the electrode material for a lithium-ion battery consisting of an electrode composition including electrode active material particles and a frame-like member placed annularly so as to surround the electrode composition; a pressure reduction packaging section for reducing pressure and packaging the electrode material for a lithium-ion battery together with the substrate so as to fix the electrode composition by the frame-like member and a packaging material; and a pressure molding section for roll-pressing the electrode composition fixed by the frame-like member and the packaging material, and a method for manufacturing electrode for a lithium-ion battery, comprising the steps of: placing an electrode material for a lithium-ion battery on a substrate, the electrode material for a lithium-ion battery consisting of an electrode composition including electrode active material particles and a frame-like member placed annularly so as to surround the electrode composition; pressure reduction packaging for reducing pressure and packaging the electrode material for a lithium-ion battery together with the substrate to fix the electrode composition by the frame-like member ana a packaging material; and pressure molding the electrode composition by roll-pressing the electrode composition fixed by the frame-like member and the packaging material.

### EFFECT OF THE INVENTION

According to the present invention, it is possible to provide a manufacturing method for an electrode for a lithium-ion battery and a manufacturing device thereof, which suppress the occurrence of cracking and chipping in the electrode layer and also make molding defects unlikely to occur even when the roll rotation speed is increased.

### BRIEF DESCRIPTION OF DRAWINGS

FIG. 1 is a perspective view schematically showing an example of a placing process.

FIG. 2 is a perspective view schematically showing an example of a placing process.

FIG. 3 is a perspective view schematically showing an example of a pressure reduction packaging process.

FIG. 4 is a perspective view schematically showing an example of a pressure reduction packaging process.

FIG. 5 is a cross sectional view schematically showing an example of a pressure molding process.

FIG. 6 is a perspective view schematically showing an example of an electrode for a lithium-ion battery.

FIG. 7 is a perspective view schematically showing the layer structure of another example of the electrode material for a lithium-ion battery.

FIG. 8 is a perspective view schematically showing the layer structure of still another example of the electrode material for a lithium-ion battery.

FIG. 9 is a photograph of the electrode material for a lithium-ion battery according to Example 1 after the pressure molding process.

FIG. 10 is a photograph of the electrode material for a lithium-ion battery according to Example 2 after the pressure molding process.

FIG. 11 is a photograph of the electrode material for a lithium-ion battery according to Comparative Example 1 after the pressure molding process.

FIG. 12 is a photograph of the electrode material for a lithium-ion battery according to Comparative Example 2 after the pressure molding process.

FIG. 13 is a photograph of the electrode material for a lithium-ion battery according to Comparative Example 3 after the pressure molding process.

FIG. 14 is a photograph of the electrode material for a lithium-ion battery according to Comparative Example 4 after the pressure molding process.

FIG. 15 is a photograph of the electrode material for a lithium-ion battery according to Comparative Example 5 after the pressure molding process.

FIG. 16 is a photograph of the electrode material for a lithium-ion battery according to Comparative Example 6 after the pressure molding process.

FIG. 17 is a perspective view schematically showing an example of a manufacturing method of an electrode for a lithium-ion battery using the manufacturing device for a lithium-ion battery electrode.

FIG. 18 is a cross sectional view with a line X-X in FIG. 17.

FIG. 19 is a cross sectional view with a line A-A in FIG. 18.

FIG. 20 is a cross sectional view with a line B-B in FIG. 18.

FIG. 21 is a cross sectional view with a line C-C in FIG. 18.

FIG. 22 is a cross sectional view with a line D-D in FIG. 18.

FIG. 23 is a cross sectional view with a line E-E in FIG. 18.

FIG. 24 is a cross sectional view schematically showing another example of the electrode material for a lithium-ion battery.

FIG. 25 is a cross sectional view schematically showing another example of the electrode for a lithium-ion battery.

### DESCRIPTION OF EMBODIMENTS

The present invention will be described in detail.

In the present specification, when the description will be made as a lithium-ion battery, the concept of a lithium-ion secondary battery is also included.

### Manufacturing Device for an Electrode of a Lithium-Ion Battery

A manufacturing device for an electrode of a lithium-ion battery is provided with a placing section for placing an electrode material for a lithium-ion battery on a substrate, the electrode material for a lithium-ion battery consisting of an electrode composition including electrode active material particles and a frame-like member placed annularly so as to surround the electrode composition; a pressure reduction packaging section for reducing pressure and packaging the electrode material for a lithium-ion battery together with the substrate so as to fix the electrode composition by the frame-like member and a packaging material; and a pressure molding section for roll-pressing the electrode composition fixed by the frame-like member and the packaging material.

The use of the manufacturing device for an electrode of a lithium-ion battery allows a method for manufacturing electrode for a lithium-ion battery described below to be easily implemented.

### Method for Manufacturing Electrode for a Lithium-Ion Battery

A method for manufacturing electrode for a lithium-ion battery includes the processes of placing an electrode material for a lithium-ion battery on a substrate, the electrode material for a lithium-ion battery consisting of an electrode composition including electrode active material particles and a frame-like member placed annularly so as to surround the electrode composition; pressure reduction packaging for reducing pressure and packaging the electrode material for a lithium-ion battery together with the substrate to fix the electrode composition by the frame-like member ana a packaging material; and pressure molding the electrode composition by roll-pressing the electrode composition fixed by the frame-like member and the packaging material.

In the present specification, the pressure reduction packaging has the same meaning as the vacuum packaging, and the pressure reduction packaging section has the same meaning as the vacuum packaging section. Further, the pressure reduction packaging process has the same meaning as the vacuum packaging process.

In the method for manufacturing electrode for a lithium-ion battery described above, the electrode composition including electrode active material particles is subjected to pressure reduction and packaged together with the substrate so as to apply pressure to the electrode composition fixed by roll-pressing the frame-like member and a packaging material by roll-pressing. The frame-like member is placed so as to surround the electrode composition, so that the shape of the electrode composition after pressure-molding corresponds to the inner shape of the frame-like member. Thus, the shape of the frame-like member is adjusted, so that the processing of the electrode composition is not required, and thus cracking and chipping can be prevented. Further, since the inside of the packaging material is under pressure reduction (vacuum), the electrode composition is unlikely to collapse due to the release of compressed air. Therefore, the molding defects are unlikely to occur even if the roll rotation speed is increased.

Next, an example of implementing the above manufacturing method for an electrode for a lithium-ion battery using the above-described manufacturing device for a lithium-ion battery electrode will be explained. However, the above-described manufacturing method for an electrode for a lithium-ion battery can be implemented without using the above-described manufacturing device for a lithium-ion battery electrode.

First, each of the processes constituting the manufacturing method of an electrode material for a lithium-ion battery will be described.

### Placing Process

In the placing process, the electrode material for a lithium-ion battery is placed on the substrate.

In a case of using the manufacturing device for an electrode of a lithium-ion battery, the placing process is carried out by the placing section.

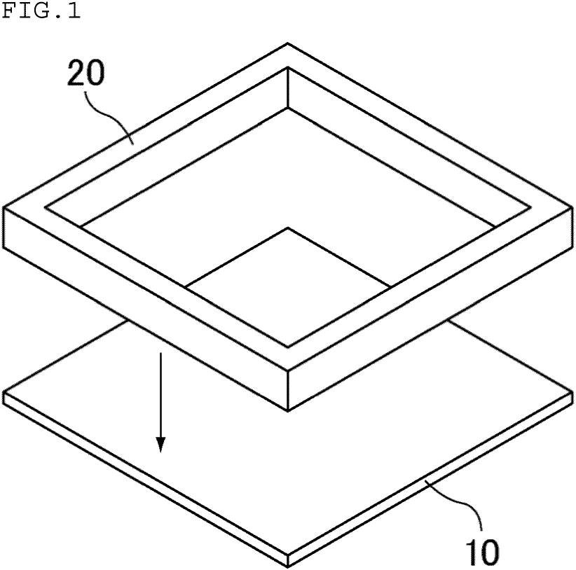

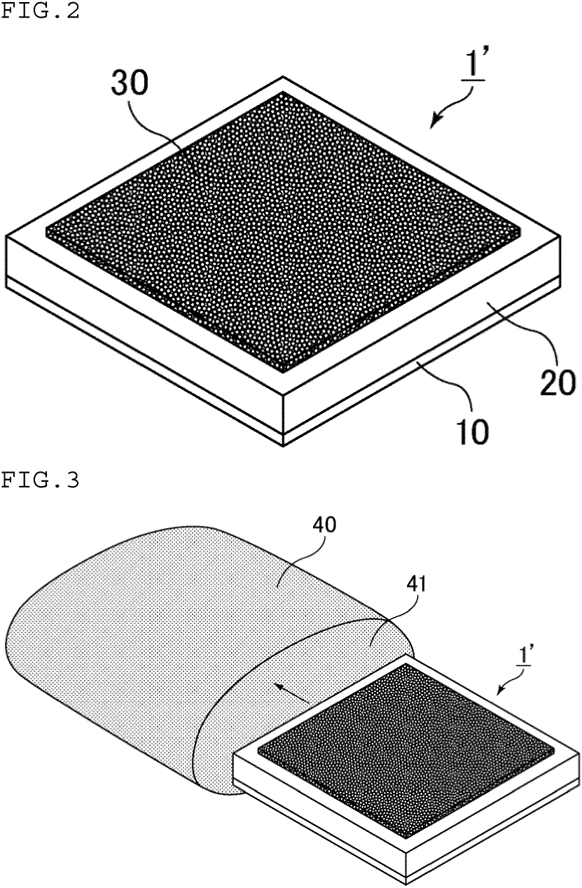

FIGS. 1 and 2 are diagrams schematically showing of an example of the placing process.

First, as shown in FIG. 1, a frame member 20 is placed on the substrate 10.

Then, as shown in FIG. 2, on the substrate 10, the electrode composition 30 containing the electrode active material particles is placed in the space inside the frame member 20 on the substrate 10. The electrode material 1′ for a lithium-ion battery consisting of the frame member 20 and the electrode composition 30 can be placed on the substrate 1 by the above-described procedure.

A means for placing the frame member 20 on the substrate 10 and a means for placing the electrode composition 30 in the space inside the frame member 20 are the placing section in the manufacturing device for an electrode of a lithium-ion battery.

Examples of the placing section include a combination of a placing mechanism that places the frame-like member molded in a predetermined shape in advance on the substrate and an electrode composition supply mechanism that supplies the electrode composition inside the frame member placed on the substrate.

In the placing process, the order in which the electrode composition and the frame-like member are placed on the substrate is not particularly limited, but it is preferable to firstly place the frame-like member on the substrate, and then place the electrode composition inside the frame-like member.

The method of placing the frame-like member on a substrate is not particularly limited, and includes methods such as placing the frame-like member formed into a predetermined shape on the substrate in advance or forming a frame member on the substrate by giving a frame-like member precursor, which will become a frame-like member by a predetermined operation, on the substrate. Examples of the predetermined operations include, for example, heating and light irradiation.

### Pressure Reduction Packaging Process

In the pressure reduction packaging process, the electrode material for a lithium-ion battery placed on the substrate in the placing process is subjected to pressure reduction and packaged together with the substrate to fix the electrode composition by the above-described frame-like member and the packaging material to obtain the electrode composition fixed by the frame member and packaging material (hereinafter also referred to as vacuum package).

The pressure reduction (vacuum) herein refers to a degree of pressure reduction (degree of vacuum) with a gauge pressure of -50 kPa or less with respect to atmospheric pressure.

In a case of using the manufacturing device for an electrode of a lithium-ion battery, the pressure reduction packaging process is implemented by the pressure reduction packaging section.

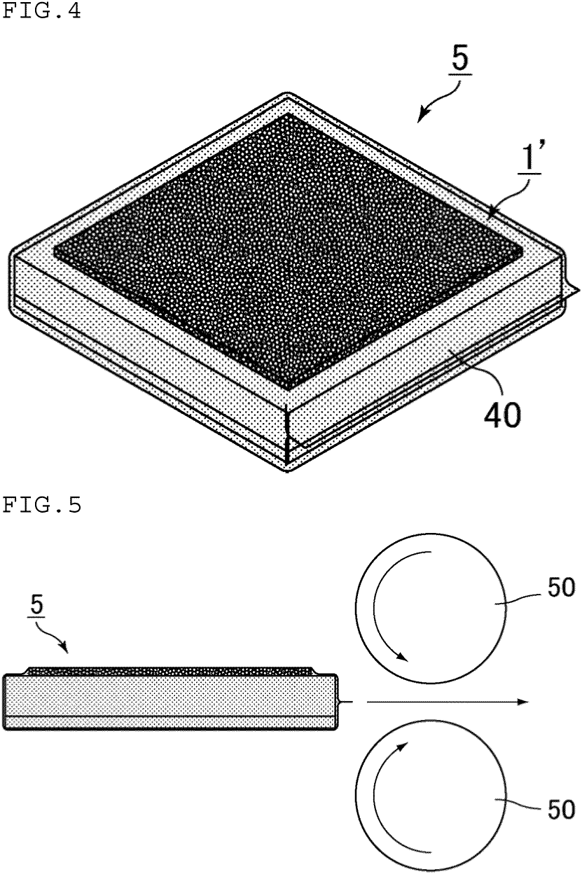

FIGS. 3 and 4 are diagrams schematically showing an example of a pressure reduction packaging process.

As shown in FIG. 3, the electrode material 1′ for a lithium-ion battery placed on the substrate 10 is accommodated together with the substrate in a bag-shaped packaging material 40 having an opening 41, and then heat-sealed while the inside of the packaging material 40 is applied with pressure reduction through the opening 41 to reduce pressure and package the electrode material 1′ for a lithium-ion battery together with the substrate 10, whereby obtaining a vacuum package 5 shown in FIG. 4.

In a case where the processes shown in FIGS. 3 and 4 are implemented using the manufacturing device for an electrode of a lithium-ion battery, the combination of an accommodation mechanism that accommodates the electrode material for a lithium-ion battery, together with the substrate, in a bag-shaped packaging material having an opening, a pressure reduction mechanism that applies pressure reduction to the packaging material through the opening, and a heat sealing mechanism that heat-seals the packaging material is the pressure reduction packaging section.

The shape and material of the packaging material may be set appropriately in accordance with the shape of the electrode material for a lithium-ion battery and the pressure reduction method.

For example, the vacuum package can be manufactured by a method in which, with the electrode material and substrate for a lithium-ion battery, together with the substrate, sandwiched between two film packaging materials, three sides are heat-sealed, air in the packaging material is removed from the remaining one side, and finally heat sealing is applied.

The materials that constitutes the packaging materials are not limited, but include polypropylene.

The degree of vacuum of the vacuum package obtained in the pressure reduction packaging process is preferably -70 kPa or less, and more preferably -80 kPa or less.

If the degree of vacuum of the vacuum package exceeds -70 kPa, the force externally applied to the vacuum package (atmospheric pressure) is not sufficient, and thus in the pressure molding process described below, the electrode composition may flow out of the frame-like member. More specifically, the achievable degree of vacuum in the pressure reduction packaging section is preferably -70 kPa or less.

The part that requires pressure reduction (vacuum) in the pressure reduction packaging process is a small space inside the packaging material. Therefore, vacuum packaging can be produced in less time than the time required to apply pressure reduction to the pressure molding device as a whole.

### Pressure Molding Process

In the pressure molding process, the electrode composition (vacuum package) fixed by the frame-like member and the packaging material is roll-pressed.

The roll pressing is preferably performed by a pair of rollers.

In a case of using the manufacturing device for an electrode of a lithium-ion battery, it is preferable that the pressure molding section is equipped with the pair of rollers, and that the pressure molding process is implemented by the pair of rollers.

In the vacuum package, the electrode composition is fixed by the frame-like member and the packaging material. Therefore, the electrode composition does not flow out even if pressure is applied to the electrode composition. Since the frame-like member is placed to surround the electrode composition, the shape of the electrode composition after the pressure molding process corresponds to the inner shape of the frame-like member. Thus, the shape of the frame-like member is adjusted, so that the processing of the electrode composition after the pressure molding is not required, and thus cracking and chipping can be prevented. Further, since the inside of the packaging material is under pressure reduction (vacuum), the electrode composition is unlikely to collapse due to the release of compressed air. Therefore, the molding defects are unlikely to occur even if the roll rotation speed is increased.

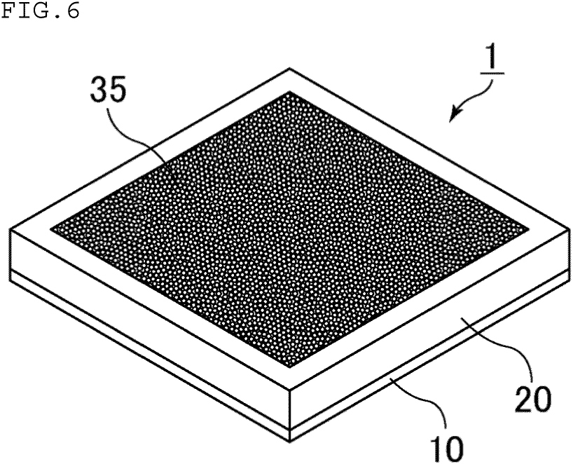

FIG. 5 is a cross sectional view schematically showing an example of the pressure molding process, and FIG. 6 is a perspective view schematically showing an example of an electrode for a lithium-ion battery.

As shown in FIG. 5, the vacuum package 5 is pressurized by passing the vacuum package 5 between the press rolls 50 to pressure-mold the electrode composition 30. The packaging material 40 is removed from the pressurized vacuum package 5, so that, it is possible to obtain an electrode 1 for a lithium-ion battery composed of the molded electrode composition 35 and the frame-like member 20 on the substrate 10, as shown in FIG. 6.

In a case where the substrate used in the placing process is an electrode current collector, an electrode for a lithium-ion battery in which the electrode composition is connected to the electrode current collector can be obtained.

The method of pressure molding the vacuum package is roll pressing, preferably by a pair of rollers.

The interval between the pair of rollers is preferably at least three times the volume average particle diameter of the electrode active material particles from the viewpoint of alleviating the rise of the intense pressing force that occurs instantaneously when the rollers ride up to the starting edge of the frame-like member. Further, the interval between the pair of rollers is preferably 20 mm or less.

The electrode material for a lithium-ion battery may be heated during the pressure molding process.

In a case where the substrate is the electrode current collector, there is no need to separate the substrate from the electrode for a lithium-ion battery. Therefore, the electrode material for a lithium-ion battery is heated in the pressure molding processeso that the frame-like member and the substrate which serves as the electrode current collector can be bonded.

The heating temperature is preferaby at or higher than the melting point of the resin that constitutes the frame-like member and below the temperature that would adversely affect the packaging material that constitues the vacuum package.

The pressure molding process may be performed continuously or intermittently.

When the pressure molding process is performed intermittently, transfer of the substrate may be stopped, the vacuum package may be pressurized while the vacuum package is not being transferred, and then the vacuum package may be transferred again after the pressure is released.

The method of reducing pressure of the pressure molding section itself without going through the vacuum package does not correspond to the pressure reduction packaging process and the pressure molding process in the manufacturing method of an electrode for a lithium-ion battery of the present invention.

The electrode for a lithium-ion battery is manufactured by the processes described above.

The resulting electrode for a lithium-ion battery is accommodated in the packaging material, and the space inside the packaging material is under pressure reduction (vacuum), so that deterioration of the electrode composition due to contact with moisture can be suppressed. In addition, since the space inside the packaging material is under pressure reduction (vacuum), the electrode composition is fixed by atmospheric pressure, and the electrode composition can be suppressed from flowing due to vibration.

As a result, the manufacturing method of an electrode for a lithium-ion battery of the present invention can manufacture the electrode for a lithium-ion battery with excellent storage and conveying properties.

In a case of manufacturing a lithium-ion battery using the electrode for a lithium-ion battery manufactured by the above-described manufacturing method of an electrode for a lithium-ion battery, the lithium ion battery can be manufactured by, for example, removing the packaging material and the substrate from the vacuum package, connecting the electrode current collector to the electrode composition in combination with an electrode that serves as the counter electrode via a separator, adding an electrolyte to the electrode composition and the separator as needed, and then accommodating it in a battery outer package.

In a case where the substrate used in manufacturing the electrode material for a lithium-ion battery is an electrode current collector, the process of connecting the electrode current collector to the electrode composition can be omitted by not removing the substrate.

Next, the electrode composition, the frame-like member, and the substrate used in the placing process will be described.

The thickness of the electrode composition is not limited, but is preferably greater than or equal to the thickness of the frame-like member.

The ratio of the thickness of the electrode composition to the thickness of the frame-like member is preferably 100 to 200%, preferably 100 to 150%, and more preferably 110 to 130%.

In the case where the frame-like member is difficult to deform, the ratio of the thickness of the electrode composition to the thickness of the frame-like member that is less than 100% may not achieve sufficient pressure molding of the electrode composition in the pressure molding process described below.

If the ratio of the electrode composition to the thickness of the frame-like member exceeds 100%, the electrode composition will protrude from the frame-like member. Since the electrode composition is fixed in the packaging material during the pressure reduction packaging process, the protrusion of the electrode composition from the frame-like member is not a problem during the pressure molding process.

The frame-like member preferably contains polyolefin with a melting point of 75 to 90° C.

Polyolefin having a melting point of 75 to 90° C. may has, or may not have, a polar group in the molecule.

The polar groups include a hydroxy group (—OH), a carboxyl group (—COOH), a formyl group (—CHO), a carbonyl group (═CO), an amino group (—NH2), a thiol group (—SH), 1,3-dioxo-3-oxypropylene group, and the like.

It is possible to confirm whether polyolefin has a polar group or not by analyzing polyolefin by Fourier transform infrared spectroscopy (FT-IR) or nuclear magnetic resonance spectroscopy (NMR) analysis.

Examples of polyolefin having a melting point between 75 to 90° C. include MELTHENE (registered trademark) G (melting point: 77° C.) manufactured by Tosoh Corporation, ADMER XE070 (melting point: 8° C.) manufactured by Mitsui Chemicals, Inc., and the like.

MELTHENE (registered trademark) G manufactured by Tosoh Corporation Tosoh Corporation is an example of a resin having a polar group, and ADMER XE070 manufactured by Mitsui Chemicals, Inc., is an example of a resin without a polar group.

The frame-like member may contain a non-conductive filler in addition to polyolefin with a melting point of 75 to 90° C.

Examples of the non-conductive filler include inorganic fibers such as a glass fiber, inorganic particles such as silica particles, and the like.

A part of the frame-like member may be composed of a heat-resistant annular support member.

In a case where a part of the frame-like member is composed of a heat-resistant annular support member, the mechanical strength and heat resistance property of the frame-like member can be improved.

Since the heat-resistant annular support member has low adhesiveness with the electrode current collector and the separator, the heat-resistant annular support member is preferably placed in the center of the frame-like member in the thickness direction.

In this case, a layer containing polyolefin with a melting point of 75 to 90° C., a layer containing polyolefin with a melting point of 75 to 90° C., a heat-resistant annular support member, and a layer containing polyolefin with a melting point of 75 to 90° C., which have identical shapes in plan view, are placed in this order from the substrate side. The above configuration allows mechanical strength and heat resistance to be given to the frame-like member while enhancing adhesion to the electrode current collector and separator.

It is desirable for the heat-resistant annular support member to contain a heat-resistant resin composition with a melting temperature of 150° C. or higher, and it is more desirable for the heat-resistant annular support member to contain a heat-resistant resin composition with a melting temperature of 200° C. or higher.

The heat-resistant annular support member contains a heat-resistant resin composition with a melting temperature of 150° C. or higher, so that the frame-like member is more resistant to deformation against heat.

The melting temperature (also simply referred to as melting point) of a heat-resistant resin composition is measured by differential scanning calorimetry in accordance with JIS K712 1-1987.

Examples of the resin constituting the heat-resistant resin composition include thermosetting resins (epoxy resin, polyimide, etc.), engineering resins [polyamide (nylon 6, melting temperature: about 230° C.; nylon 66, melting temperature: about 270° C., etc.), polycarbonate (also called PC, melting temperature: about 150° C.) and polyether ether ketone (also called PEEK, melting temperature: about 330° C.)] and high-melting thermoplastic resins {polyethylene terephthalate (also called PET, melting temperature: about 250° C.), polyethylene naphthalate (also called PEN, melting temperature: about 260° C.) and high melting point polypropylene (melting temperature: about 160 to 170° C.), etc.}.

The high-melting point thermoplastic resin refers to a thermoplastic resin having a melting temperature of 150° C. or higher as measured by differential scanning calorimetry in accordance with JIS K7121-1987.

The heat-resistant resin composition preferably contains at least one resin selected from the group consisting of polyamide, polyethylene terephthalate, polyethylene naphthalate, high-melting point polypropylene, polycarbonate and polyetheretherketone.

Heat resistant resin compositions may contain a filler.

The inclusion of the filler in heat-resistant resin compositions can improve the melting temperature.

Examples of the above filler include inorganic fillers such as glass fiber and carbon fiber.

Examples of the heat-resistant resin composition containing a filler include glass fiber impregnated with epoxy resin before curing (also called glass epoxy) and carbon fiber reinforced resin.

The distance between the external and internal shapes of the frame-like member when viewed from the top is also referred to as the width of the frame-like member.

The width of the frame-like member is not limited, but is preferably 3 to 20 mm.

If the width of the frame-like member is less than 3 mm, the mechanical strength of the frame-like member may be insufficient, and the electrode composition may leak out of the frame-like member. On the other hand, if the width of the frame-like member exceeds 20 mm, the proportion of the electrode composition may decrease, resulting in a decrease in energy density.

The thickness of the frame-like member is not limited, but is preferably 0.1 to 10 mm.

Examples of the electrode active material particles include positive electrode active material particles or negative electrode active material particles.

An electrode composition using the positive electrode active material particles as electrode active material particles is also referred to as a positive electrode composition, and an electrode composition using the negative electrode active material particles as electrode active material particles is also referred to as an negative electrode composition.

The frame-like member surrounding the positive electrode composition annularly is also referred to as a positive electrode frame-like member, and a frame-like member ringed around the negative electrode composition is also referred to as a negative electrode frame-like member.

Examples of the positive electrode active material particles include particles of composite oxides of lithium and transition metals {composite oxides with one transition metal (LiCoO₂, LiNiO₂, LiAlMnO₄, LiMnO₂, and LiMn₂O₄, etc.), composite oxides with two transition metal elements (LiFeMnO₄, LiNi₁₋ₓCoₓO₂, LiMn_{1-y}Co_{y}O₂, LiNi_{⅓}Co_{⅓}Al_{⅓}O₂, and LiNi_{0.8}Co_{0.15}Al_{0.05}O₂) and composite oxides with three or more metal elements [for example, LiMₐM′_{b}M″_{c}O₂ (M, M′ and M″ are each different transition metal elements and satisfy a+b+c=1, such as LiNi_{⅓}Mn_{⅓}Co_{⅓}O₂, etc.], lithium-containing transition metal phosphates (such as LiFePO₄, LiCoPO₄, LiMnPO₄ and LiNiPO₄), transition metal oxides (such as MnO₂ and V2O₅), transition metal sulfides (e.g. MoS₂ and TiS₂) and conductive polymers (such as polyaniline, polypyrrole, polythiophene, polyacetylene and poly-p-phenylene and polyvinylcarbazole), two or more of which may be used together.

The lithium-containing transition metal phosphates may have some of the transition metal sites replaced by other transition metals.

Examples of the negative electrode active material particles include carbon materials [graphite, graphitizable carbon, amorphous carbon, calcined resin (e.g., phenol resin, furan resin, etc. are calcined into carbon), coke (e.g., pitch coke, needle coke, petroleum coke, etc.) and carbon fiber], silicon materials [silicon, silicon oxide (SiOx), silicon-carbon composites (carbon particles coated with silicon and/or silicon carbide, silicon particles or silicon oxide particles coated with carbon and/or silicon carbide, and silicon carbide), silicon alloys (silicon-aluminum alloys, silicon-lithium alloys, silicon-nickel alloys, silicon-iron alloys, silicon-titanium alloys, silicon-manganese alloys, silicon-copper alloys, silicon-tin alloys, etc.)], conductive polymers (e.g., polyacetylene and polypyrrole), metals (e.g., tin, aluminum, zirconium and titanium), metal oxides (e.g., titanium oxide and lithium-titanium oxide), metal alloys (such as lithium-tin alloys and lithium-aluminum alloys) and lithium-aluminum-manganese alloys, etc.), and mixtures of these and carbon-based materials.

For the negative electrode active material particles listed above that do not contain lithium or lithium ions inside, pre-doping treatment may be applied to make part or all of the negative electrode active material particles contain lithium or lithium ions in advance.

Among these, carbon-based materials, silicon-based materials, and mixtures thereof are preferable from the viewpoint of battery capacity, and graphite, graphite-resistant carbon, and amorphous carbon are more preferable as carbon-based materials, and silicon oxide and silicon-carbon composite are more preferable as silicon-based materials.

The average particle size of the electrode active material particles is preferably 5 to 200 µm.

The average particle diameter of electrode active material particles means the particle diameter (Dv50) at 50% integration value in the particle size distribution obtained by the microtrac method (laser diffraction and scattering method) in the particle size distribution obtained by the microtrac method (laser diffraction and scattering method). The microtrac method is a method for determining the particle size distribution using scattered light obtained by irradiating particles with laser light. A laser diffraction and scattering type particle size distribution analyzer [such as Microtrac manufactured by MicrotracBell Corp.] can be used to measure the volume average particle diameter.

The electrode active material particles may be coated active material particles, in which at least part of the surface is coated by a coating layer containing a polymer compound.

When the electrode active material particles are surrounded and coated with a coating layer, the volume change of the electrode is alleviated, and the expansion of the electrode is suppressed.

The coated active material particles when the positive electrode active material particles are used as electrode active material particles are referred to as coated positive electrode active material particles, and the coated active material particles when the negative electrode active material particles are used as electrode active material particles are referred to as coated negative electrode active material particles.

As the polymer compound constituting the coating layer (also referred to as coating polymer compound), the polymer compound described in Japanese Unexamined Patent Application Publication No. 2017-054703 as a resin for coating non-aqueous secondary battery active material can be suitably used.

The coating layer may contain conductive auxiliary agent, as described below, if necessary.

The weight percentage of the coating polymer compound in the electrode composition is preferably 0.1 to 10% by weight, based on the weight of the electrode composition.

If the content of the coating polymer compound in the electrode composition is less than 0.1 wt% based on the weight of the electrode composition, the content of coating polymer compound in the electrode composition may be too small, resulting in electrode cracking and reduced moldability.

On the other hand, if the content of the coating polymer compound in the electrode composition exceeds 10% by weight based on the weight of the electrode composition, the content of the coating polymer compound in the electrode composition may be too high, resulting in increased electrical resistance.

The weight percentage of the electrode active material particles in the electrode composition is preferably 70 to 95% by weight based on the weight of the electrode composition.

In a case where the electrode active material particles are the coated active material particles, the coating layer comprising the coated active material particles shall not be included in the weight of the electrode active material particles.

In addition to the electrode active material particles, the electrode composition may contain a conductive auxiliary agent, a known solution-drying type electrode binder (also referred to as a binding agent), and an adhesive resin. Electrolytes and solvents that constitute non-aqueous electrolyte solutions used in the manufacture of lithium-ion battery may be contained.

However, the electrode composition preferably does not contain any known electrode binder.

The conductive auxiliary agent is selected from materials having conductivity.

Specifically, Examples thereof include, but not limited to, metals [nickel, aluminum, stainless steel (SUS), silver, copper, and titanium, etc.], carbon [graphite and carbon black (acetylene black, Ketjen black, furnace black channel black, thermal ramp black, etc.), and mixtures thereof.

One of these conductive auxiliary agents may be used alone or in combination with two or more of them. Alloys or metal oxides of these may also be used. From the viewpoint of electrical stability, aluminum, stainless steel, carbon, silver, copper, titanium, and mixtures thereof are preferable; silver, aluminum, stainless steel, and carbon are more preferable; and carbon is still more preferable. These conductive auxiliary agents may also be particle-based ceramic materials or resin materials which are coated with a conductive material (a metal among the conductive auxiliary materials mentioned above) by plating and the like.

The average particle size of the conductive auxiliary agent is not particularly limited, but from the viewpoint of the electrical characteristics of the battery, 0.01 to 10 µm is preferable, 0.02 to 5 µm is more preferable, and 0.03 to 1 µm is still more preferable. The “particle diameter” herein means the largest distance L between any two points on the contour line of the conductive auxiliary agent. As the value of the “average particle diameter”, a value shall be adopted which is calculated using an observation means such as a scanning electron microscope (SEM) or a transmission electron microscope (TEM) to be obtained as the average particle diameter of particles observed in several to several tens of fields of view.

The shape (form) of the conductive auxiliary agent is not limited to the form of particles, but may be in a form other than particles, e.g., the form that is in practical use as so-called filler-type conductive materials such as carbon nanotubes and the like.

The conductive auxiliary agent may be conductive fibers whose shape is fibrous.

Examples of the conductive fiber include carbon fibers such as PAN-based carbon fiber and pitch-based carbon fiber, conductive fibers made by uniformly dispersing conductive metals or graphite in synthetic fibers, metallic fibers made by fibering metals such as stainless steel, conductive fibers in which the surface of organic fiber is coated with metal, conductive fibers in which the surface of organic fiber is coated with resin containing conductive substances, and the like. Among these conductive fibers, carbon fiber is preferred. Further, polypropylene resin kneaded with graphene is also preferred.

If the conductive aid is a conductive fiber, the average fiber diameter thereof is preferably 0.1 to 20 µm.

The weight percentage of the conductive auxiliary agent in the electrode composition is preferably 0 to 5% by weight based on the weight of the electrode composition.

Examples of the known solution-drying type electrode binder include starch, polyvinylidene fluoride (PVdF), polyvinyl alcohol (PVA), carboxymethylcellulose (CMC), polyvinylpyrrolidone (PVP), polytetrafluoroethylene (PTFE), styrene-butadiene rubber (SBR), polyethylene (PE), and polypropylene (PP).

However, the content of known electrode binders is preferably less than 2.0% by weight, based on the weight of the total electrode composition.

The weight percentage of the known electrode binder in the electrode composition is preferably 0 to 2% by weight based on the weight of the electrode composition, more preferably 0 to 0.5% by weight, and still more preferably 0 to 0.5% by weight.

The electrode composition preferably contains an adhesive resin rather than a known electrode binder.

In a case where the electrode composition contains a known solution-drying type electrode binder described above, a drying process is required after forming a pressure-molded body to integrate the electrode composition. When an adhesive resin is included, the electrode composition can be integrated with a slight pressure at room temperature without a drying process. In a case where the drying process is not performed, shrinkage and cracking of the compression-molded body due to heating do not occur, which is preferable.

The solution-drying type electrode binder means one that dries and solidifies by volatilizing solvent components to firmly fix the electrode active material particles to one another. On the other hand, the adhesive resin means a resin having adhesiveness (the property of bonding by applying slight pressure without using water, solvent, heat, etc.).

The solution-drying electrode binders and the adhesive resins are different materials.

As an adhesive resin, it is possible to suitably use a polymer compound that constitutes the coating layer (such as the non-aqueous secondary battery active material coating resin described in Japanese Unexamined Patent Application Publication No. HEI 05-05 4703), whose glass transition temperature is adjusted below room temperature by mixing a small amount of organic solvent, and those described as an thickening agent in Japanese Unexamined Patent Application Publication No. HEI 10-255805, and the like.

The weight percentage of the adhesive resin contained in the electrode composition is preferably 0 to 2% by weight based on the weight of the electrode composition.

The percentage of the total weight of resin components (the coating polymer compound, the binder for electrodes, and the adhesive resin) in the electrode composition is preferably 0.1 to 10% by weight.

As electrolytes, those used in known non-aqueous electrolyte solutions can be used, and examples thereof include lithium salts of inorganic acids such as LiPF₆, LiBF₄, LiSbF₆, LiAsF₆ and LiClO₄, lithium salts of organic acids such as LiN(CF₃SO₂)₂, LiN(C₂F₅SO₂)₂ and LiC(CF₃SO₂)₃. Among these, LiPF₆ is preferred from the viewpoint of battery output and charge/discharge cycle characteristics.

As the solvent, those used in known non-aqueous electrolytes can be used; for example, lactone compounds, cyclic or chain carbonates, chain carboxylic esters, cyclic or chain ethers, phosphate esters, nitrile compounds, amide compounds, sulfones, sulfolanes, and mixtures thereof can be used.

The type of the substrate used in the placing process is not limited, but may be an electrode current collector. In addition to the electrode current collectors, resin films and metal foils may also be used as the substrate.

In a case where a substrate other than the electrode current collector is used, the electrode current collector may be further placed between the substrate and the electrode material for the lithium-ion battery.

Examples of the electrode current collector include a positive electrode current collector or a negative electrode current collector.

Examples of the material constituting the positive electrode current collector include copper, aluminum, titanium, stainless steel, nickel, calcined carbon, conductive polymers, and conductive glass. Further, a resin current collector consisting of a conductive agent and a resin may also be used as a positive electrode current collector.

Examples of the material constituting the negative electrode current collector include copper, aluminum, titanium, stainless steel, nickel and their alloys. Among these materials, copper is preferred from the viewpoint of reduction in weight, corrosion resistance, and high conductivity. The negative electrode current collector may be a current collector made of calcined carbon, conductive polymers, conductive glass, and the like, or a resin current collector composed of a conductive agent and a resin.

For both the positive and negative electrode current collectors, the same conductive agents as those contained in the electrode composition can be suitably used as conductive auxiliary agent for the resin current collector.

Examples of the resin constituting the resin current collector include polyethylene (PE), polypropylene (PP), polymethylpentene (PMP), polycyclo-olefin (PCO), polyethylene terephthalate (PET), polyether-nitrile (PEN), polytetrafluoroethylene (PTFE), styrene-polyethylene (SPSE), polyacrylonitrile (PAN), polymethylpentene (PMP), polymethyl methacrylate (PMMA), polyvinylidene fluoride (PVdF), epoxy resins, silicone resins, or mixtures of these resins.

From the viewpoint of electrical stability, polyethylene (PE), polypropylene (PP), polymethylpentene (PMP), and polycyclo-olefin (PCO) are preferred, and polyethylene (PE), polypropylene (PP) and polymethylpentene (PMP) are more preferred.

The shape of the substrate is not particularly limited, but is preferable the same as the outer shape of the frame-like member in a plan view, or substantially similar to the outer shape of the frame-like member and slightly smaller than the frame-like member.

### Other Embodiments

In the manufacturing method of an electrode for a lithium-ion battery, the electrode material for a lithium-ion battery placed on the substrate may have two different electrode compositions.

As an example of an electrode material for a lithium-ion battery having two types of electrode compositions, an electrode material for a lithium-ion battery can be provided having an electrode material for a lithium-ion battery having a first electrode composition including first electrode composition particles, a first frame-like member placed annularly to surround the first electrode composition, a separator disposed on the first electrode composition and the first frame-like member, a second electrode composition including second electrode composition particles, and a second frame-like member placed annularly to surround the second electrode composition.

One of the first electrode active material particles and the second electrode active material particles is a positive electrode active material particle and the other is an negative electrode active material particle.

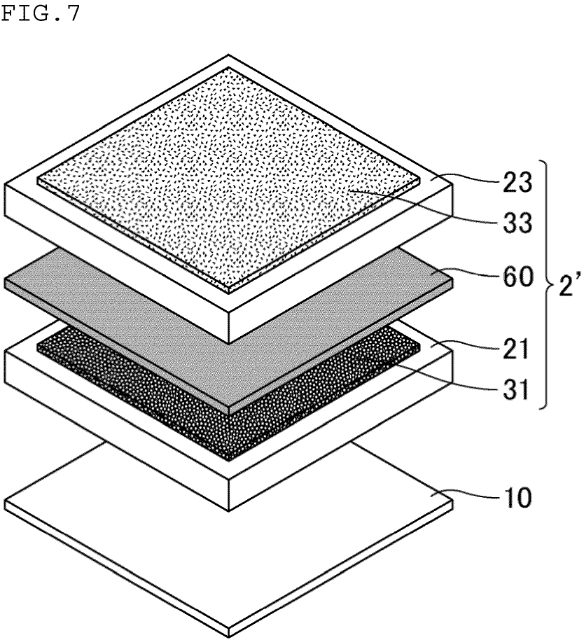

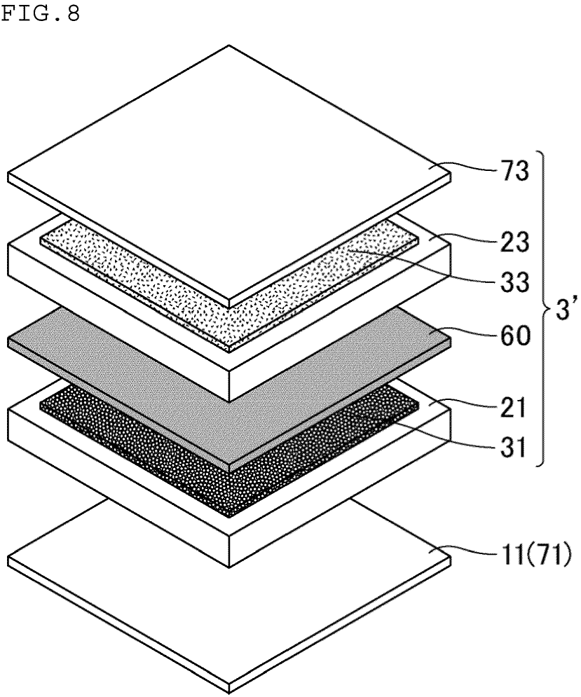

Examples of the electrode material for a lithium-ion battery with two types of electrode compositions will be described with reference to FIGS. 7 and 8.

FIG. 7 is a perspective view schematically showing the layer structure of another example of the electrode material for a lithium-ion battery.

An electrode material 2′ for a lithium-ion battery shown in FIG. 7 consists of a positive electrode composition 31 placed on the substrate 10, a positive electrode frame-like member 21 covering the periphery of the positive electrode composition 31, a separator 60, and a positive electrode composition 3. 21 that covers around the positive electrode composition 31, a separator 60, a negative electrode composition 33 facing the positive electrode composition 31 via the separator 60, and a negative electrode frame-like member 23 covering the periphery of the negative electrode composition 33.

In the electrode material 2′ for a lithium-ion battery, the positive electrode composition 31 and the negative electrode composition 33 are placed so as to face each other via the separator 6. Therefore, in a case where the electrode for a lithium-ion battery manufactured using the electrode material 2′ for a lithium-ion battery is used in the manufacture of a lithium-ion battery, the process of combining with the counter electrode can be omitted.

FIG. 8 is a perspective view schematically showing the layer structure of still another example of the electrode material for a lithium-ion battery.

The electrode material 3′ for a lithium-ion battery shown in FIG. 8 consists of a positive electrode composition 31 placed on a substrate 11 that serves as a positive electrode current collector 71, a positive electrode frame-like member 21 covering the periphery of the positive electrode composition 31, a separator 60, a negative electrode composition 33 facing the positive electrode composition 31 via the separator 60, a negative electrode frame-like member 23 covering the periphery of the negative electrode composition 33, and a negative electrode current collector 73 placed on the negative electrode composition 33.

In the electrode material 3′ for a lithium-ion battery, the positive electrode composition 31 and the negative electrode composition 33 are placed so as to face each other via the separator 60. Further, in the electrode material 3′ for a lithium-ion battery, the negative electrode current collector 73 is placed on the negative electrode composition 33, and the substrate 11 is composed of the positive electrode current collector 71. Therefore, when the electrode for a lithium-ion battery manufactured using the electrode material 3′ for a lithium-ion battery is used in the manufacture of lithium-ion battery, the processes of combining with the counter electrode and connecting the electrode current collector to the electrode composition can be omitted.

The positive electrode frame-like member and the negative electrode frame-like member is preferably in a substantially identical shape in plan view.

### EXAMPLE

Next, the invention will be specifically described by means of the examples, however, the invention is not limited to the examples without departing from the gist of the invention. Unless otherwise noted, part means parts by weight and % means percent by weight.

### Example 1: Preparation of Polymer Compound For Coating and Solutions Thereof

A four-necked flask equipped with a stirrer, a thermometer, a reflux condenser, a dropping funnel, and a nitrogen gas inlet tube was charged with 407.9 parts of DMF, and the temperature was raised to 75° C. Subsequently, a monomer mixture containing 242.8 parts of methacrylic acid, 97.1 parts of methyl methacrylate, 242.8 parts of 2-ethylhexyl methacrylate, and 116.5 parts of DMF, and an initiator solution containing 1.7 parts of 2,2′-azobis(2,4-dimethylvaleronitrile) and 4.7 parts of 2,2′-azobis(2-methylbutyronitrile) dissolved in 58.3 parts of DMF were continuously added dropwise through the dropping funnel over four hours under stirring, while blowing nitrogen into the four-necked flask, to carry out radical polymerization. After the completion of the dropwise addition, the reaction was continued for three hours at 75° C. Subsequently, the temperature was raised to 80° C., and the reaction was continued for three hours to obtain a copolymer solution having a resin concentration of 50% by weight. 789.8 parts of DMF was added to the obtained copolymer solution, whereby a polymer compound solution for coating was obtained.

### Production Example 2: Preparation of Electrolyte

LiN(FSO₂)₂ was dissolved in a mixed solvent of ethylene carbonate (EC) and propylene carbonate (PC) (1: 1 in terms of volume ratio) at a rate of 1.0 mol/L, whereby an electrolyte solution was prepared.

### Example 3: Preparation of Coated Positive Electrode Active Material Particles

93.7 parts of a positive electrode active material powder (LiNi_{0.8}Co_{0.15}Al_{0.05}O₂ powder, volume average particle size: 4 µm) was placed in an all-purpose mixer, High Speed Mixer FS25 [manufactured by EARTHTECHNICA Co., Ltd.], and at room temperature and in a state of the powder being stirred at 720 rpm, 1 part of a polymer compound solution for coating obtained in Production Example 1 was added dropwise over 2 minutes, and then the resultant mixture was further stirred for 5 minutes.

Next, in a state of the resultant mixture being stirred, 1 part of acetylene black [DENKA BLACK (registered trade name) manufactured by Denka Company Limited] was divisionally added as a conducting agent in 2 minutes, and stirring was continued for 30 minutes. Then, the pressure was reduced to 0.01 MPa while maintaining the stirring, the temperature was subsequently raised to 140° C. while maintaining the stirring and the degree of pressure reduction, and the stirring, the degree of pressure reduction, and the temperature were maintained for 8 hours to distill off the volatile matter. The obtained powder was classified with a sieve having a mesh size of 212 µm to obtain a coated positive electrode active material.

### Example 4: Preparation of a Frame-Like Members

MELTHENE (registered trademark) G (melting point: 77° C.) manufactured by Tosoh Corporation was extruded into a film having the thickness of 150 µm, and stamped into an annular shape that is a square with an inner shape of 11 mm × 11 mm and an outer shape of 15 mm × 15 mm, whereby the frame-like member was obtained.

### Example 1

### Placing Process

95 parts of the coated electrode active material particles prepared in Production Example 3, 5 parts of acetylene black as a conductive auxiliary agent, and 30 parts of the electrolyte prepared in Production Example 2 were mixed to prepare the positive electrode composition.

One frame-like member manufactured in Production Example 4 was placed on a SUS plate (15 mm × 15 mm, 200 µm thick), which serves as a substrate, and the positive electrode composition was injected inside the frame-like member to the same thickness as that of the frame-like member, whereby the electrode material for a lithium-ion battery was prepared.

### Pressure Reduction Packaging Process

The electrode material for a lithium-ion battery was accommodated in packaging material made of PP (20 mm × 25 mm), and the pressure was reduced until a gauge pressure of -95 kPa was reached and the opening was heat-sealed to obtain a vacuum package.

### Pressure Molding Process

The vacuum package was roll-pressed by a pair of rollers to form the positive electrode composition. The rotation speed of the roller was 50 mm/s. The interval between the pair of rollers was 320 µm.

### Evaluation of Molding Condition

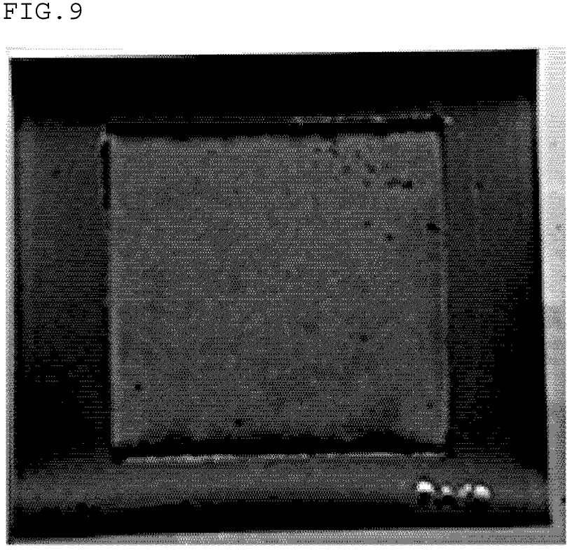

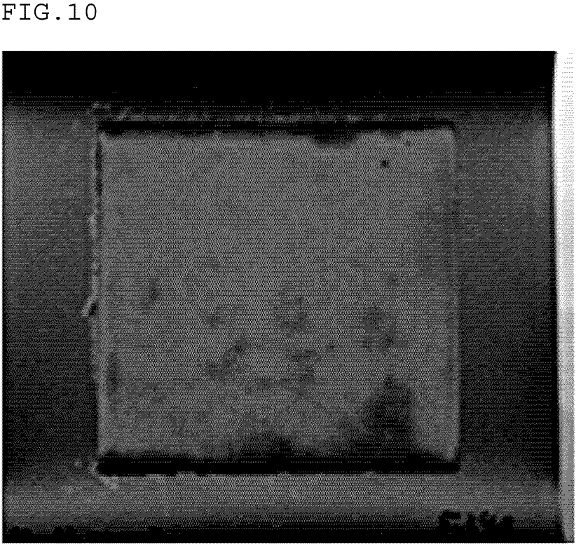

The condition of the positive electrode composition after the pressure molding process was visually observed to check for any shape disorder, and the evaluation was performed in accordance with the following criteria. A photograph of the state of the positive electrode composition after the pressure molding process is shown in FIG. 9. FIG. 9 is a photograph of the electrode material for a lithium-ion battery according to Example 1 after the pressure molding process.

o: No irregularity in the shape of the positive electrode composition is observed.

Δ: The positive electrode composition is deformed.

×: Traces of the positive electrode composition spewed out and the positive electrode composition is significantly deformed.

### Example 2, Comparative Examples 1 to 6

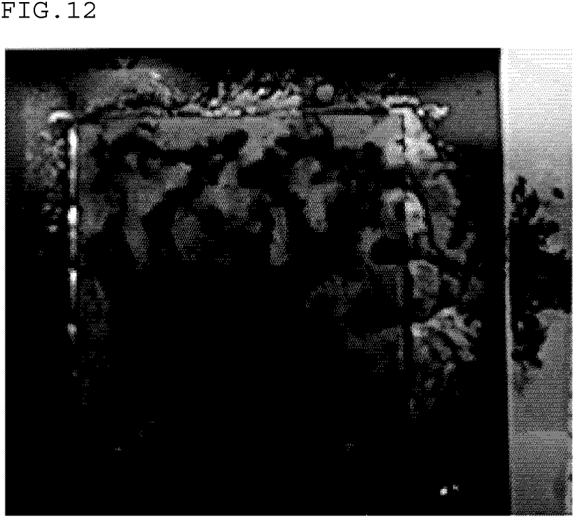

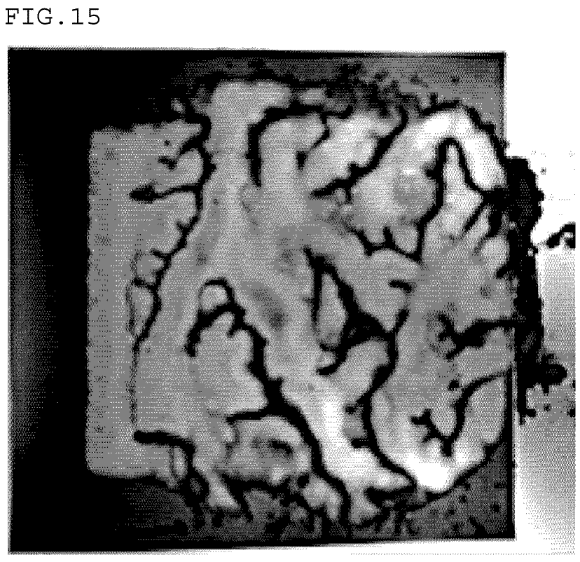

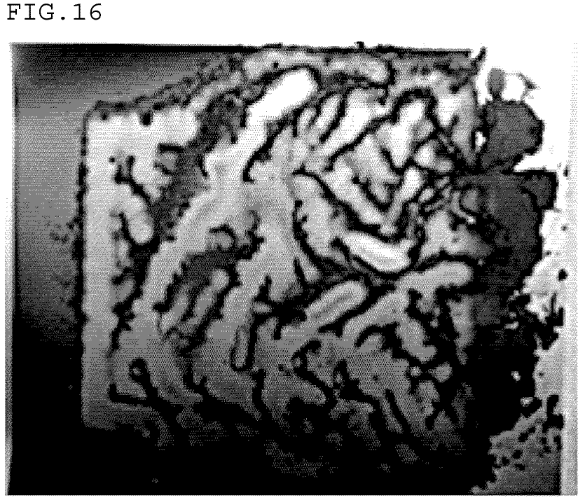

The electrode for a lithium-ion battery was manufactured by changing the presence/absence of a frame-like member, the degree of vacuum in the pressure reduction packaging process, and the roll rotation speed as shown in Table 1, and the state of the positive electrode composition was visually observed. The results are shown in Table 1 and FIGS. 10 to 16. FIGS. 10 to 16 are photographs of the electrode material for a lithium-ion battery according to Example 2 and Comparative Examples 1 to 6 after the pressure molding process.

For Comparative Examples 3 to 6 in which a frame-like member was not used, a PP frame having the same dimensions as the frame-like member used in Examples 1 to 2 and Comparative Examples 1 to 2 is placed on the substrate in the placing process, and the frame was removed after the positive electrode composition was injected, so that the positive electrode composition was made to have the same shape as that in Examples 1 to 2 and Comparative Examples 1 to 2.

For Comparative Examples 1 to 2 and 5 to 6 in which the degree of vacuum was 0 kPa, in the pressure reduction packaging process, the electrode material for a lithium-ion battery was accommodated in the packaging material, and then the gas inside the packaging material was discharged while lightly holding the packaging material by hand so as not to deform the shape of the positive electrode composition, thereby achieving the seat sealing.

### Example 3

The electrode material for a lithium-ion battery according to Example 3 was prepared by the same procedure as in Example 1 except that two laminated frame-like member manufactured in Production Example 4 were placed on a SUS plate (15 mm × 15 mm, 200 µm thick), which serves as a substrate, the positive electrode composition was injected inside the frame-like member, and then one of the frame-like members was removed, and the molded state was evaluated. The results are shown in Table 1. The thickness of the positive electrode composition before being accommodated in the packaging material was 200% of the thickness of the frame-like member. The interal between a pair of rollers used in the Pressure molding process was also the same as in Example 1.

TABLE 1

| | Frame-like member | Degree of vacuum [kPa] | Rotation speed [mm/s] | Evaluation of state of moldability |
|---|---|---|---|---|
| Example 1 | Present | -95 | 50 | ◯ |
| Example 2 | Present | -95 | 100 | ◯ |
| Example 3 | Present | -95 | 50 | ◯ |
| Comparative Example 1 | Present | 0 | 50 | ◯ |
| Comparative Example 2 | Present | 0 | 100 | ◯ |
| Comparative Example 3 | Absent | -95 | 50 | ◯ |
| Comparative Examples 4 | Absent | -95 | 100 | ◯ |
| Comparative Example 5 | Absent | 0 | 50 | ◯ |
| Comparative Example 6 | Absent | 0 | 100 | ◯ |

As shown in Table 1, and FIGS. 9 and 10, no disorder in shape was observed in the electrodes for a lithium-ion battery manufactured by the manufacturing method of an electrode for a lithium-ion battery.

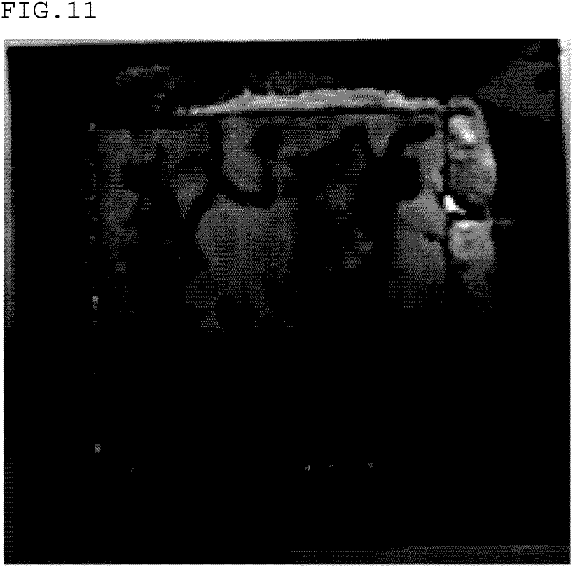

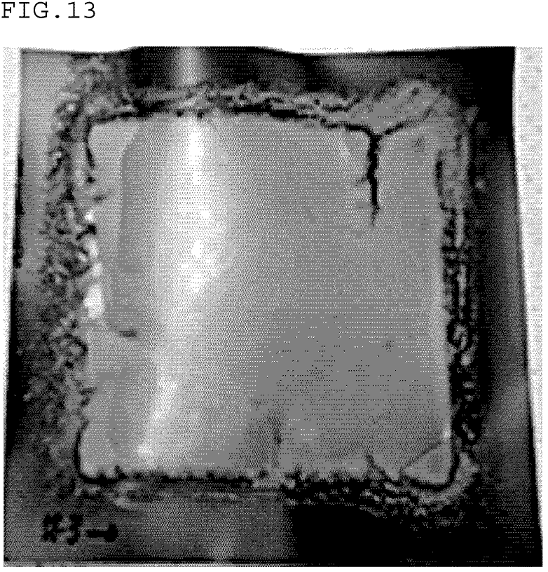

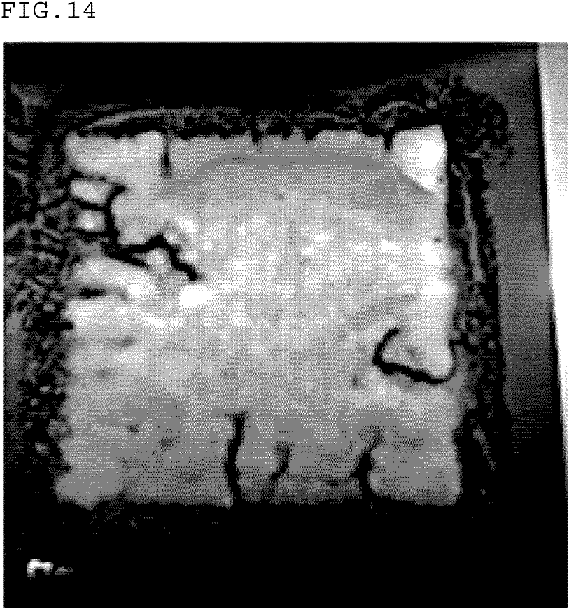

On the other hand, in Comparative Examples 3 to 4 in which the vacuum package was fabricated but no frame-like member was used, the positive electrode composition was deformed as shown in FIGS. 13 and 14. Further, in Comparative Examples 1 to 2 and 5 to 6 in which the degree of vacuum of the vacuum package was at 0 kPa, as shown in FIGS. 11, 12, 15, and 16, there were traces of positive electrode composition spouting out regardless of the presence of a frame-like member, and the positive electrode composition was significantly deformed. The spouting out of the positive electrode composition was more prominent at higher roll rotation speeds.

As a result, it can be found that the method for manufacturing electrodes for a lithium-ion battery is less likely to cause forming defects even when the roll rotation speed is increased.

The lithium-ion (secondary) batteries have been widely used in recent years for various applications as high-capacity, compact, and lightweight rechargeable batteries.

In the lithium-ion battery, the electrode is generally configured by applying of a positive electrode or negative electrode active material to a positive or negative current collector, respectively, using binder. In the case of a bipolar battery, a positive electrode layer is formed by applying positive electrode active material using a binder to one side of the current collector, and a negative electrode layer is formed by applying negative electrode active material using a binder to the opposite side.

One of methods for manufacturing such a lithium-ion battery is to use a roll press to compression-mold the electrode active material.

Japanese Patent No. 5772429 discloses a method for manufacturing an electrode layer by supplying electrode material powder containing an electrode active material and a binding agent to a region surrounded by a pair of rolls and an end rectifying member, and pressure-molding the supplied electrode material powder in the region surrounded by the pair of rolls and the end rectifying member.

Japanese Unexamined Patent Application Publication No. 2018-85182 discloses a method of manufacturing an electrode, comprising the steps of molding an electrode composite layer by feeding a granulated material containing an electrode active material, a binder, and a solvent between a pair of rolls and pressure-molding the granulated material with the pair of rolls, and placing the electrode composite layer on an electrode current collector.

In the method described in Japanese Patent No. 5772429, only a continuous electrode layer in the MD direction can be fabricated, so that additional processing of the electrode layer is required in order to use it as an electrode for a lithium-ion battery, and thus cracking and chipping in the electrode layer are likely to occur during this processing.

In addition, both the methods disclosed in Japanese Patent No. 5772429 and Japanese Unexamined Patent Application Publication No. 2018-85182 include the process of roll pressing the electrode active material in the state of powder. In the process concerned, air may be rolled into the roll and compressed together with the electrode active material powder, and then the electrode shape collapses (in other words, the formability of the electrode composition is degraded) due to the compressed air blowing out.

As a method to solve this problem, the inventors have found that the process of roll pressing electrode active material in powder form is performed in a pressure reduction environment. By the configuration discovered by the inventors, it is possible to solve the aforementioned problem because air is prevented from being rolled into the rolls and compressed together with the electrode active material powder in the process of roll pressing the electrode active material in a powder state. Among such configurations found by the inventors, Japanese Patent No. 6126546 and No. 6255546 discloses one of them in so far as the configuration in which a prescribed process is performed under a pressure reduction environment.

Specifically, Japanese Patent No. 6126546 discloses the feature in which an negative electrode compound slurry containing an electrode binder and a negative electrode active material is applied to the surface of the negative electrode current collector and thermally roll-pressed in a nitrogen atmosphere or vacuum. However, Japanese Patent No. 6126546 merely discloses the feature in which, when copper foil is used as the negative electrode current collector, in order to prevent oxidation of the copper, it is necessary to be performed in a non-oxygen environment, for example, in a vacuum, to prevent oxidation of copper (for example, paragraphs 0018, 0020, etc. of Japanese Patent No. 6126546), and thus the specific configuration of performing the process under a vacuum environment is not disclosed. Rather, as disclosed in FIG. 4B of Japanese Patent No. 6126546, the configuration using a nitrogen displacement box (non-oxygen gas displacement chamber) to place not only the negative electrode current collector but also the entire unit including the heat-press roller and cooling roller under a non-oxygen environment may cause the entire manufacturing device to become larger in size. If the entire manufacturing device becomes larger, it cannot be applied to continuous product manufacturing due to the time required for pressure adjustment between reduced pressure and atmospheric pressure, and resultingly a new problem arises, i.e., the manufacturing cost cannot be controlled.

Further, Japanese Patent No. 6255546 discloses a process for laminating a plate workpiece, such as a liquid crystal display or an organic EL display, etc., to another plate-shaped workpiece, such as a touch panel or cover film, in a vacuum environment. However, Japanese Patent No. 6255546 merely discloses a configuration in which the entire workpiece is stored in a vacuum chamber in order to perform the lamination process under such a vacuum environment, which resultingly leads to increase in the overall size, similar to Japanese Patent No. 6126546. Thus, the same problem as the aforementioned patent No. 6126546 arises in the case of Japanese Patent No. 6255546.

Therefore, there is a need for a manufacturing device for a lithium-ion battery electrodes that can suppress cracking and chipping of the electrode layer and reduce the moldability of the electrode composition, as well as shorten pressure adjustment time and reduce manufacturing costs.

Specifically, a manufacturing device for an electrode of a lithium-ion battery described below is provided with a conveying section for conveying a conveying substrate with an electrode material for a lithium-ion battery mounted thereon, the electrode material for a lithium-ion battery consisting of an electrode composition including electrode active material particles and a frame-like member placed annularly so as to surround the electrode composition; a coating film supplying section for covering a surface of the electrode material for a lithium-ion battery on the side opposite to a surface on which the conveying substrate is placed; a pressure reduction packaging section for reducing pressure in a space sandwiched between the conveying substrate and the coating film so as to fix the electrode composition placed on the conveying substrate by the frame-like member and a packaging material; and a pressure molding section for roll-pressing the electrode composition fixed by the frame-like member and the packaging material.

The manufacturing device for a lithium-ion battery electrode concerned can suppress cracking and chipping of the electrode layer and reduce the moldability of the electrode composition, as well as shorten pressure adjustment time and reduce manufacturing costs.

The manufacturing device for an electrode for a lithium-ion battery will be described below.

### Manufacturing Device for a Lithium-Ion Battery Electrode

The a manufacturing device for an electrode of a lithium-ion battery described below is provided with a conveying section for conveying a conveying substrate with an electrode material for a lithium-ion battery mounted thereon, the electrode material for a lithium-ion battery consisting of an electrode composition including electrode active material particles and a frame-like member placed annularly so as to surround the electrode composition; a coating film supplying section for covering a surface of the electrode material for a lithium-ion battery on the side opposite to a surface on which the conveying substrate is placed; a pressure reduction packaging section for reducing pressure a space sandwiched between the conveying substrate and the coating film so as to fix the electrode composition placed on the conveying substrate by the frame-like member and a packaging material; and a pressure molding section for roll-pressing the electrode composition fixed by the frame-like member and the packaging material.

In the following description herein, the pressure reduction packaging section has the same meaning as the fixing section, and the pressure reduction packaging process has the same meaning as the fixing process.

The use of the manufacturing device for an electrode of a lithium-ion battery allows a method for manufacturing electrode for a lithium-ion battery described below to be easily implemented.

### Manufacturing Method for an Electrode for a Lithium-Ion Battery

The manufacturing method for an electrode for a lithium-ion battery comprises the processes of: conveying a conveying substrate with an electrode material for a lithium-ion battery mounted thereon, the electrode material for a lithium-ion battery consisting of an electrode composition including electrode active material particles and a frame-like member placed annularly so as to surround the electrode composition; covering a surface of the electrode material for a lithium-ion battery on the side opposite to a surface on which the conveying substrate is placed; reducing pressure in a space sandwiched between the conveying substrate and the coating film so as to fix the electrode composition placed on the conveying substrate by the frame-like member and a packaging material; and roll-pressing the electrode composition fixed by the frame-like member and the packaging material.

In the manufacturing method for an electrode for a lithium-ion battery, in the pressure reduction packaging process, the pressure in a space sandwiched between the conveying substrate and the coating film is reduced so as to fix the electrode composition placed on the conveying substrate by the frame-like member and a packaging material. Since the frame-like member is placed to surround the electrode composition, the shape of the electrode composition after the pressure molding process corresponds to the inner shape of the frame-like member. Thus, the shape of the frame-like member is adjusted, so that the processing of the electrode composition after the pressure molding is not required, and thus cracking and chipping can be prevented. Further, since the space sandwiched between the conveying substrate and the coating film is subjected to pressure reduction in the coating process, air compression is suppressed in the pressure molding process. Moreover, since the space that have to be subjected to pressure reduction in the pressure reduction packaging process is merely a small space sandwiched between the conveying substrate and the coating film, the pressure adjustment time can be shortened and production costs can be reduced.

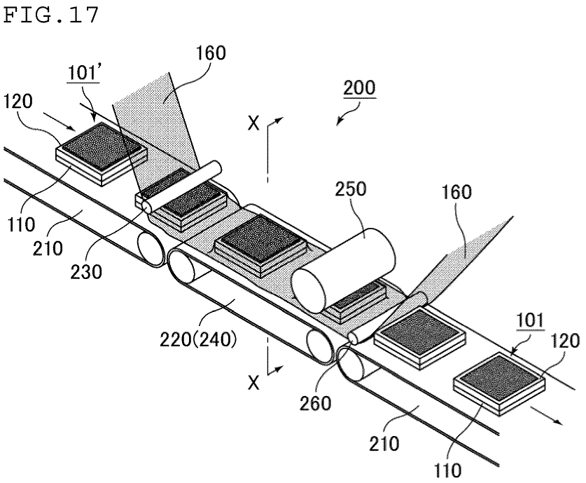

FIG. 17 is a perspective view schematically showing an example of a manufacturing method of an electrode for a lithium-ion battery using the manufacturing device for a lithium-ion battery electrode, and FIG. 18 is a cross sectional view with a line X-X in FIG. 17.

FIGS. 17 and 18 schematically show a method of manufacturing an electrode 101 for a lithium-ion battery from an electrode material 101′ using a manufacturing device 200 for a lithium-ion battery electrode. The manufacturing device 200 for an electrode for a lithium-ion battery is provided with a belt conveyor 210 that is a first conveying section for conveying the electrode material 101′ for a lithium-ion battery, a belt conveyor 210 that is a second conveying section for conveying electrode material 101′ for a lithium-ion battery, a coating film supplying section 230 for supplying coating film 160, a fixing section (pressure reduction packaging section) 240, a pressure molding section 250, and a separating section 260. An attraction belt conveyor 220 is the second conveying section as well as the fixing section (pressure reduction packaging section) 240.

The manufacturing method shown in FIGS. 17 and 18 successively performs the electrode material 101 for a lithium-ion battery consists of a conveying process (at the position with a line A-A in FIG. 18) where the electrode material 101′ for a lithium-ion battery is placed on the conveying substrate 110 and conveyed together with the conveying substrate 110, a coating process (at the position with a line B-B in FIG. 18), and a fixing process (pressure reduction packaging process) (at the position with a line C-C in FIG. 18), a pressure molding process (at the position with a line D-D in FIG. 18), and a separating process (at the position with a line E-E in FIG. 18).

The conveying substrate 110 and the electrode material 101′ for a lithium-ion battery are conveyed in the direction of the arrows shown in FIGS. 17 and 18.

More specifically, the manufacturing device 200 performs the processing by the coating film supplying section 230 (coating process), the processing by the fixing section (pressure reduction packaging section) 240 (fixing process (pressure reduction packaging process)), the processing by the pressure molding section 250 (pressure molding process), and the processing by the separating section 260 (separating process) while conveying the conveying substrate 110 by the first conveying section 210 and the second conveying section 220. The manufacturing device for an electrode for a lithium-ion battery may be configured so that the coating process, the fixing process (pressure reduction packaging process), and the pressure molding process are continuously performed while conveying the conveying substrate 110. The manufacturing device for an electrode for a lithium-ion battery may also be configured so that the coating process, the fixing process (pressure reduction packaging process), the pressure molding process, and the separating process are continuously performed while conveying the conveying substrate 110.

The conveying section (conveying device) may be controlled by a controller (not shown: e.g., a sequencer) so as to continuously perform the coating process, the fixing process (pressure reduction packaging process), the pressure molding process, and the separating process, or the operator may also convey the conveying substrate 110 by hand so that the aforementioned processes are continuously performed while conveying the conveying substrate 110.

In the conveying process, the coating process, and the separating process, the belt conveyor 210 that is the first conveying section is used to convey the material 101′ for a lithium-ion battery electrode and the conveying substrate 110 are conveyed.

On the other hand, in the fixing process (pressure reduction packaging process) and the pressure molding process, the attraction belt conveyor 220 that is the second conveying section is used to convey the electrode material 101′ for a lithium-ion battery and the conveying substrate 110 are conveyed.

The first and second conveying sections are the conveying sections in the manufacturing device for a lithium-ion battery electrodes. Although a configuration composed of a plurality of conveying sections (first and second conveying sections) is shown as an example of a conveying section in the manufacturing device for electrodes for a lithium-ion battery, it is not limited to this example. More specifically, the conveying section may be, for example, a single substrate conveying device or a plurality of substrate conveying devices, as long as the conveying section is equipped with a function to convey the conveying substrate 110 that can perform the aforementioned process, and the configuration can be changed as needed.

Each process will be described in detail below.

### Conveying Process

In the conveying process, the electrode material for a lithium-ion battery is placed on the conveying substrate and conveyed together with the conveying substrate.

The electrode material for a lithium-ion battery may be placed directly on the conveying substrate or on a substrate separate from the conveying substrate.

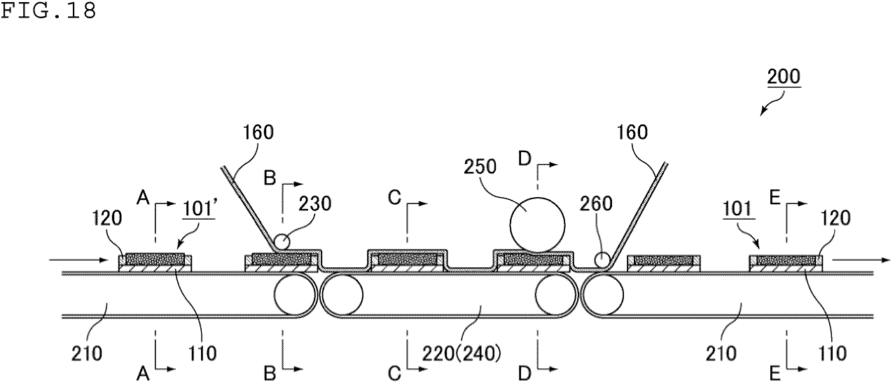

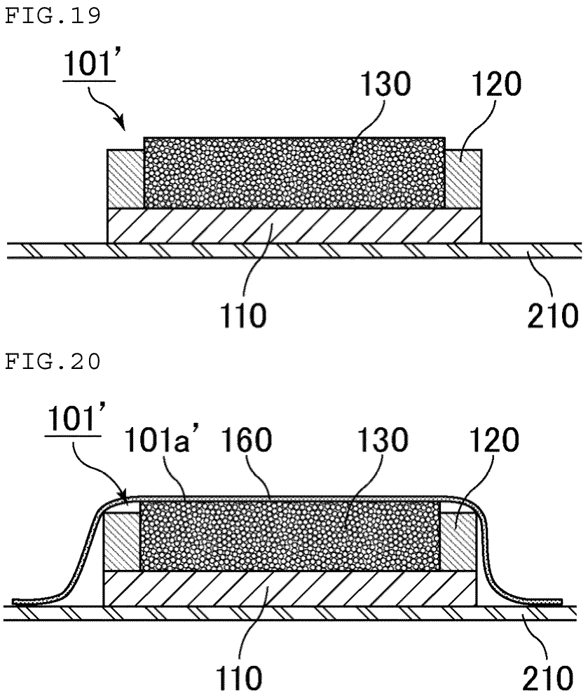

FIG. 19 is a cross sectional view with a line A-A in FIG. 18 and schematically shows an example of the conveyance process.

As shown in FIG. 19, in the conveying process, the electrode material 101′ for a lithium-ion battery is placed on the conveying substrate 110 and conveyed together with the conveying substrate 110.

The electrode material 101′ for a lithium-ion battery consists of an electrode composition 130 including electrode active material particles placed on the conveying substrate 110, and a frame-like member 120 that is placed annularly so as to surround the electrode composition 130.

The order in which the electrode composition 130 and the frame-like member 120 are placed on the conveying substrate 110 is not particularly limited, but it is preferable to firstly place the frame-like member 120 on the conveying substrate 110, and then place the electrode composition 130 inside the frame-like member 120.

The electrode material for a lithium-ion battery may be placed directly on the conveying substrate or through other materials.

Example of the materials placed between the conveying substrate and the electrode material for a lithium-ion battery include, for example, an electrode current collector.

The method of placing the frame-like member on the conveying substrate is not particularly limited, and includes methods such as placing the frame-like member formed into a predetermined shape on the conveying substrate in advance or forming a frame member on the conveying substrate by giving a frame-like member precursor, which will become a frame-like member by a predetermined operation, on the conveying substrate. Examples of the predetermined operations include, for example, heating and light irradiation.

The thickness of the electrode composition is not limited, but is preferably greater than or equal to the thickness of the frame-like member.

The ratio of the thickness of the electrode composition to the thickness of the frame-like member is preferably 100 to 200%, preferably 100 to 150%, and more preferably 110 to 130%.

In the case where the frame-like member is difficult to deform, the ratio of the thickness of the electrode composition to the thickness of the frame-like member that is less than 100% may not achieve sufficient pressure molding of the electrode composition in the pressure molding process described below.

If the ratio of the electrode composition to the thickness of the frame-like member exceeds 100%, the electrode composition will protrude from the frame-like member. Since the electrode composition is fixed in the frame-like member and the coating film during the pressure reduction packaging process, the protrusion of the electrode composition from the frame-like member is not a problem during the pressure molding process.

The frame-like member preferably contains polyolefin with a melting point of 75 to 90° C.

Polyolefin having a melting point of 75 to 90° C. may has, or may not have, a polar group in the molecule.

The polar groups include a hydroxy group (—OH), a carboxyl group (—COOH), a formyl group (—CHO), a carbonyl group (═CO), an amino group (—NH2), a thiol group (—SH), 1,3-dioxo-3-oxypropylene group, and the like.

It is possible to confirm whether polyolefin has a polar group or not by analyzing polyolefin by Fourier transform infrared spectroscopy (FT-IR) or nuclear magnetic resonance spectroscopy (NMR) analysis.

Examples of polyolefin having a melting point between 75 to 90° C. include MELTHENE (registered trademark) G (melting point: 77° C.) manufactured by Tosoh Corporation, ADMER XE070 (melting point: 8° C.) manufactured by Mitsui Chemicals, Inc., and the like.

MELTHENE (registered trademark) G manufactured by Tosoh Corporation Tosoh Corporation is an example of a resin having a polar group, and ADMER XE070 manufactured by Mitsui Chemicals, Inc., is an example of a resin without a polar group.

The frame-like member may contain a non-conductive filler in addition to polyolefin with a melting point of 75 to 90° C.

Examples of the non-conductive filler include inorganic fibers such as a glass fiber, inorganic particles such as silica particles, and the like.

A part of the frame-like member may be composed of a heat-resistant annular support member.

In a case where a part of the frame-like member is composed of a heat-resistant annular support member, the mechanical strength and heat resistance property of the frame-like member can be improved.

Since the heat-resistant annular support member has low adhesiveness with the electrode current collector and the separator, the heat-resistant annular support member is preferably placed in the center of the frame-like member in the thickness direction.

In this case, a layer containing polyolefin with a melting point of 75 to 90° C., a layer containing polyolefin with a melting point of 75 to 90° C., a heat-resistant annular support member, and a layer containing polyolefin with a melting point of 75 to 90° C., which have identical shapes in plan view, are placed in this order from the conveying substrate side (electrode current collector side). The above configuration allows mechanical strength and heat resistance to be given to the frame-like member while enhancing adhesion to the electrode current collector and separator.

It is desirable for the heat-resistant annular support member to contain a heat-resistant resin composition with a melting temperature of 150° C. or higher, and it is more desirable for the heat-resistant annular support member to contain a heat-resistant resin composition with a melting temperature of 200° C. or higher.

The heat-resistant annular support member contains a heat-resistant resin composition with a melting temperature of 150° C. or higher, so that the frame-like member is more resistant to deformation against heat.

The melting temperature (also simply referred to as melting point) of a heat-resistant resin composition is measured by differential scanning calorimetry in accordance with JIS K712 1-1987.

Examples of the resin constituting the heat-resistant resin composition include thermosetting resins (epoxy resin, polyimide, etc.), engineering resins [polyamide (nylon 6, melting temperature: about 230° C.; nylon 66, melting temperature: about 270° C., etc.), polycarbonate (also called PC, melting temperature: about 150° C.) and polyether ether ketone (also called PEEK, melting temperature: about 330° C.)] and high-melting thermoplastic resins {polyethylene terephthalate (also called PET, melting temperature: about 250° C.), polyethylene naphthalate (also called PEN, melting temperature: about 260° C.) and high melting point polypropylene (melting temperature: about 160 to 170° C.), etc.}.

The high-melting point thermoplastic resin refers to a thermoplastic resin having a melting temperature of 150° C. or higher as measured by differential scanning calorimetry in accordance with JIS K7121-1987.

The heat-resistant resin composition preferably contains at least one resin selected from the group consisting of polyamide, polyethylene terephthalate, polyethylene naphthalate, high-melting point polypropylene, polycarbonate and polyetheretherketone.

Heat resistant resin compositions may contain a filler.

The inclusion of the filler in heat-resistant resin compositions can improve the melting temperature.

Examples of the above filler include inorganic fillers such as glass fiber and carbon fiber.

Examples of the heat-resistant resin composition containing a filler include glass fiber impregnated with epoxy resin before curing (also called glass epoxy) and carbon fiber reinforced resin.

The distance between the external and internal shapes of the frame-like member when viewed from the top is also referred to as the width of the frame-like member.

The width of the frame-like member is not limited, but is preferably 3 to 20 mm.

If the width of the frame-like member is less than 3 mm, the mechanical strength of the frame-like member may be insufficient, and the electrode composition may leak out of the frame-like member. On the other hand, if the width of the frame-like member exceeds 20 mm, the proportion of the electrode composition may decrease, resulting in a decrease in energy density.

The thickness of the frame-like member is not limited, but is preferably 0.1 to 10 mm.

Examples of the electrode active material particles include positive electrode active material particles or negative electrode active material particles.

An electrode composition using the positive electrode active material particles as electrode active material particles is also referred to as a positive electrode composition, and an electrode composition using the negative electrode active material particles as electrode active material particles is also referred to as an negative electrode composition.

The frame-like member surrounding the positive electrode composition annularly is also referred to as a positive electrode frame-like member, and a frame-like member ringed around the negative electrode composition is also referred to as a negative electrode frame-like member.

Examples of the positive electrode active material particles include particles of composite oxides of lithium and transition metals {composite oxides with one transition metal (LiCoO₂, LiNiO₂, LiAlMnO₄, LiMnO₂, and LiMn₂O₄, etc.), composite oxides with two transition metal elements (LiFeMnO₄, LiNi₁₋ₓCoₓO₂, LiMn_{1-y}Co_{y}O₂, LiNi_{⅓}Co_{⅓}Al_{⅓}O₂, and LiNi_{0.8}Co_{0.15}Al_{0.05}O₂ ) and composite oxides with three or more metal elements [for example, LiMₐM′_{b}M′ ′_{c}O₂ (M, M′ and M′′ are each different transition metal elements and satisfy a+b+c=1, such as LiNi_{⅓}Mn_{⅓}Co_{⅓}O₂, etc.], lithium-containing transition metal phosphates (such as LiFePO₄, LiCoPO₄, LiMnPO₄ and LiNiPO₄), transition metal oxides (such as MnO₂ and V2O₅), transition metal sulfides (e.g. MoS₂ and TiS₂) and conductive polymers (such as polyaniline, polypyrrole, polythiophene, polyacetylene and poly-p-phenylene and polyvinylcarbazole), two or more of which may be used together.

Examples of the negative electrode active material particles include carbon materials [graphite, graphitizable carbon, amorphous carbon, calcined resin (e.g., phenol resin, furan resin, etc. are calcined into carbon), coke (e.g., pitch coke, needle coke, petroleum coke, etc.) and carbon fiber], silicon materials [silicon, silicon oxide (SiOx), silicon-carbon composites (carbon particles coated with silicon and/or silicon carbide, silicon particles or silicon oxide particles coated with carbon and/or silicon carbide, and silicon carbide), silicon alloys (silicon-aluminum alloys, silicon-lithium alloys, silicon-nickel alloys, silicon-iron alloys, silicon-titanium alloys, silicon-manganese alloys, silicon-copper alloys, silicon-tin alloys, etc.)], conductive polymers (e.g., polyacetylene and polypyrrole), metals (e.g., tin, aluminum, zirconium and titanium), metal oxides (e.g., titanium oxide and lithium-titanium oxide), metal alloys (such as lithium-tin alloys and lithium-aluminum alloys) and lithium-aluminum-manganese alloys, etc.), and mixtures of these and carbon-based materials.

Among these, carbon-based materials, silicon-based materials, and mixtures thereof are preferable from the viewpoint of battery capacity, and graphite, graphite-resistant carbon, and amorphous carbon are more preferable as carbon-based materials, and silicon oxide and silicon-carbon composite are more preferable as silicon-based materials.

The average particle size of the electrode active material particles is preferably 5 to 200 µm.

The average particle diameter of electrode active material particles means the particle diameter (Dv50) at 50% integration value in the particle size distribution obtained by the microtrac method (laser diffraction and scattering method) in the particle size distribution obtained by the microtrac method (laser diffraction and scattering method). The microtrac method is a method for determining the particle size distribution using scattered light obtained by irradiating particles with laser light. A laser diffraction and scattering type particle size distribution analyzer [such as Microtrac manufactured by MicrotracBell Corp.] can be used to measure the volume average particle diameter.

The electrode active material particles may be coated active material particles, in which at least part of the surface is coated by a coating layer containing a polymer compound.

When the electrode active material particles are surrounded and coated with a coating layer, the volume change of the electrode is alleviated, and the expansion of the electrode is suppressed.

The coated active material particles when the positive electrode active material particles are used as electrode active material particles are referred to as coated positive electrode active material particles, and the coated active material particles when the negative electrode active material particles are used as electrode active material particles are referred to as coated negative electrode active material particles.

As the polymer compound constituting the coating layer (also referred to as coating polymer compound), the polymer compound described in Japanese Unexamined Patent Application Publication No. 2017-054703 as a resin for coating non-aqueous secondary battery active material can be suitably used.

The coating layer may contain conductive auxiliary agent, as described below, if necessary.

The weight percentage of the coating polymer compound in the electrode composition is preferably 0.1 to 10% by weight, based on the weight of the electrode composition.

If the content of the coating polymer compound in the electrode composition is less than 0.1 wt% based on the weight of the electrode composition, the content of coating polymer compound in the electrode composition may be too small, resulting in electrode cracking and reduced moldability.

On the other hand, if the content of the coating polymer compound in the electrode composition exceeds 10% by weight based on the weight of the electrode composition, the content of the coating polymer compound in the electrode composition may be too high, resulting in increased electrical resistance.

The weight percentage of the electrode active material particles in the electrode composition is preferably 70 to 95% by weight based on the weight of the electrode composition.

In a case where the electrode active material particles are the coated active material particles, the coating layer comprising the coated active material particles shall not be included in the weight of the electrode active material particles.

In addition to the electrode active material particles, the electrode composition may contain a conductive auxiliary agent, a known solution-drying type electrode binder (also referred to as a binding agent), and an adhesive resin. Electrolytes and solvents that constitute non-aqueous electrolyte solutions used in the manufacture of lithium-ion battery may be contained.

However, the electrode composition preferably does not contain any known electrode binder.

The conductive auxiliary agent is selected from materials having conductivity.

Specifically, Examples thereof include, but not limited to, metals [nickel, aluminum, stainless steel (SUS), silver, copper, and titanium, etc.], carbon [graphite and carbon black (acetylene black, Ketjen black, furnace black channel black, thermal ramp black, etc.), and mixtures thereof.

One of these conductive auxiliary agents may be used alone or in combination with two or more of them. Alloys or metal oxides of these may also be used. From the viewpoint of electrical stability, aluminum, stainless steel, carbon, silver, copper, titanium, and mixtures thereof are preferable; silver, aluminum, stainless steel, and carbon are more preferable; and carbon is still more preferable. These conductive auxiliary agents may also be particle-based ceramic materials or resin materials which are coated with a conductive material (a metal among the conductive auxiliary materials mentioned above) by plating and the like.

The average particle size of the conductive auxiliary agent is not particularly limited, but from the viewpoint of the electrical characteristics of the battery, 0.01 to 10 µm is preferable, 0.02 to 5 µm is more preferable, and 0.03 to 1 µm is still more preferable. The “particle diameter” herein means the largest distance L between any two points on the contour line of the conductive auxiliary agent. As the value of the “average particle diameter”, a value shall be adopted which is calculated using an observation means such as a scanning electron microscope (SEM) or a transmission electron microscope (TEM) to be obtained as the average particle diameter of particles observed in several to several tens of fields of view.

The shape (form) of the conductive auxiliary agent is not limited to the form of particles, but may be in a form other than particles, e.g., the form that is in practical use as so-called filler-type conductive materials such as carbon nanotubes and the like.

The conductive auxiliary agent may be conductive fibers whose shape is fibrous.

Examples of the conductive fiber include carbon fibers such as PAN-based carbon fiber and pitch-based carbon fiber, conductive fibers made by uniformly dispersing conductive metals or graphite in synthetic fibers, metallic fibers made by fibering metals such as stainless steel, conductive fibers in which the surface of organic fiber is coated with metal, conductive fibers in which the surface of organic fiber is coated with resin containing conductive substances, and the like. Among these conductive fibers, carbon fiber is preferred. Further, polypropylene resin kneaded with graphene is also preferred.

If the conductive aid is a conductive fiber, its average fiber diameter is preferably 0.1 to 20 µm.

The weight percentage of the conductive auxiliary agent in the electrode composition is preferably 0 to 5% by weight based on the weight of the electrode composition.

Examples of the known solution-drying type electrode binder include starch, polyvinylidene fluoride (PVdF), polyvinyl alcohol (PVA), carboxymethylcellulose (CMC), polyvinylpyrrolidone (PVP), polytetrafluoroethylene (PTFE), styrene-butadiene rubber (SBR), polyethylene (PE), and polypropylene (PP).

However, the content of known electrode binders is preferably less than 2.0% by weight, based on the weight of the total electrode composition.

The weight percentage of the known electrode binder in the electrode composition is preferably 0 to 2% by weight based on the weight of the electrode composition, more preferably 0 to 0.5% by weight, and still more preferably 0 to 0.5% by weight.

The electrode composition preferably contains an adhesive resin rather than a known electrode binder.

In a case where the electrode composition contains a known solution-drying type electrode binder described above, a drying process is required after forming a pressure-molded body to integrate the electrode composition. When an adhesive resin is included, the electrode composition can be integrated with a slight pressure at room temperature without a drying process. In a case where the drying process is not performed, shrinkage and cracking of the compression-molded body due to heating do not occur, which is preferable.

The solution-drying type electrode binder means one that dries and solidifies by volatilizing solvent components to firmly fix the electrode active material particles to one another. On the other hand, the adhesive resin means a resin having adhesiveness (the property of bonding by applying slight pressure without using water, solvent, heat, etc.).

The solution-drying electrode binders and the adhesive resins are different materials.

As an adhesive resin, it is possible to suitably use a polymer compound that constitutes the coating layer (such as the non-aqueous secondary battery active material coating resin described in Japanese Unexamined Patent Application Publication No. HEI 05-05 4703), whose glass transition temperature is adjusted below room temperature by mixing a small amount of organic solvent, and those described as an thickening agent in Japanese Unexamined Patent Application Publication No. HEI 10-255805, and the like.

The weight percentage of the adhesive resin contained in the electrode composition is preferably 0 to 2% by weight based on the weight of the electrode composition.

The percentage of the total weight of resin components (the coating polymer compound, the binder for electrodes, and the adhesive resin) in the electrode composition is preferably 0.1 to 10% by weight.

The percentage of the total weight of resin components (the coating polymer compound, the binder for electrodes, and the adhesive resin) in the electrode composition is preferably 0.1 to 10% by weight.

Electrolytes, those used in known non-aqueous electrolyte solutions can be used, and examples thereof include lithium salts of inorganic acids such as LiPF₆, LiBF₄, LiSbF₆, LiAsF₆ and LiClO₄, lithium salts of organic acids such as LiN (CF₃SO₂) ₂, LiN (C₂FₛSO₂) ₂ and LiC(CF₃SO₂)₃. Among these, LiPF₆ is preferred from the viewpoint of battery output and charge/discharge cycle characteristics.

As the solvent, those used in known non-aqueous electrolytes can be used; for example, lactone compounds, cyclic or chain carbonates, chain carboxylic esters, cyclic or chain ethers, phosphate esters, nitrile compounds, amide compounds, sulfones, sulfolanes, and mixtures thereof can be used.

The type of conveying substrate on which the electrode material for a lithium-ion battery is placed in the conveying process is not limited, but may be an electrode current collector. If the conveying substrate is an electrode current collector, the electrode material for a lithium-ion battery can be obtained that is in a state of being placed on the electrode current collector, thereby eliminating the process of bringing the electrode composition into contact with the electrode current collector when manufacturing lithium-ion battery with the electrode material for a lithium-ion battery.

In addition to electrode current collectors, resin films and metal foils may also be used as conveying substrates.

In a case where a substrate other than the electrode current collector is used, the electrode current collector may be further placed between the conveying substrate and the electrode current collector, and the frame-like member.

Examples of the electrode current collector include a positive electrode current collector or a negative electrode current collector.

Examples of the material constituting the positive electrode current collector include copper, aluminum, titanium, stainless steel, nickel, calcined carbon, conductive polymers, and conductive glass. Further, a resin current collector consisting of a conductive agent and a resin may also be used as a positive electrode current collector.

Examples of the material constituting the negative electrode current collector include copper, aluminum, titanium, stainless steel, nickel and their alloys. Among these materials, copper is preferred from the viewpoint of reduction in weight, corrosion resistance, and high conductivity. The negative electrode current collector may be a current collector made of calcined carbon, conductive polymers, conductive glass, and the like, or a resin current collector composed of a conductive agent and a resin.

For both the positive and negative electrode current collectors, the same conductive agents as those contained in the electrode composition can be suitably used as conductive auxiliary agent for the resin current collector.

Examples of the resin constituting the resin current collector include polyethylene (PE), polypropylene (PP), polymethylpentene (PMP), polycyclo-olefin (PCO), polyethylene terephthalate (PET), polyether-nitrile (PEN), polytetrafluoroethylene (PTFE), styrene-polyethylene (SPSE), polyacrylonitrile (PAN), polymethylpentene (PMP), polymethyl methacrylate (PMMA), polyvinylidene fluoride (PVdF), epoxy resins, silicone resins, or mixtures of these resins.

From the viewpoint of electrical stability, polyethylene (PE), polypropylene (PP), polymethylpentene (PMP), and polycyclo-olefin (PCO) are preferred, and polyethylene (PE), polypropylene (PP) and polymethylpentene (PMP) are more preferred.

The shape of the conveying substrate is not particularly limited, but is preferable the same as the outer shape of the frame-like member in a plan view, or substantially similar to the outer shape of the frame-like member, and larger than the outer shape of the electrode composition placed inside the frame-like member and slightly smaller than the frame-like member.

### Coating Process

In the coating process, a surface of the electrode material for a lithium-ion battery on the side opposite to a surface on which the conveying substrate is placed is covered with a coating film.

FIG. 20 is a cross sectional view with a line B-B in FIG. 18 and schematically shows an example of the coating process.

As shown in FIGS. 18 and 20, in the coating process, the roller 230 which is the coating film supply section is used to feed the coating film 160, so that the surface 101a′ of the lithium-ion battery electrode material 101′ opposite the surface on which the conveying substrate 110 is placed is covered.

In FIGS. 17 and 18, a plurality of lithium-ion battery electrode materials 101′ is covered by a long coating film 160, however, one lithium-ion battery electrode material may be covered by a single coating film.

In the coating process, the electrode material 101′ for a lithium-ion battery is preferably covered with the coating film 160 so that the coating film 160 comes into contact with all the surfaces of the electrode material 101′ for a lithium-ion battery, except the surface in contact with the conveying substrate 110.

The feeding speed of the coating film 160 is not particularly limited, but from the viewpoint of suppressing wrinkles of the coating film 160 in contact with the electrode material 101′ for a lithium-ion battery, it is preferable that the conveying speed of the electrode material 101′ for a lithium-ion battery corresponds to the feeding speed of the coating film 160.

When covering the electrode material for a lithium-ion battery with a coating film, for example, guides may be provided to adjust the position of the coating film. Further, a jig or other tool may be used to adjust the position of the conveying substrate.

The materials that make up the coating film are not particularly limited, but polypropylene is included.

### Fixing Process (Pressure Reduction Packaging Process)

In the fixing process (pressure reduction packaging process), the space sandwiched between the conveying substrate and the coating film is subjected to pressure reduction to fix the electrode composition placed on the conveying substrate by the frame-like member and the coating film.

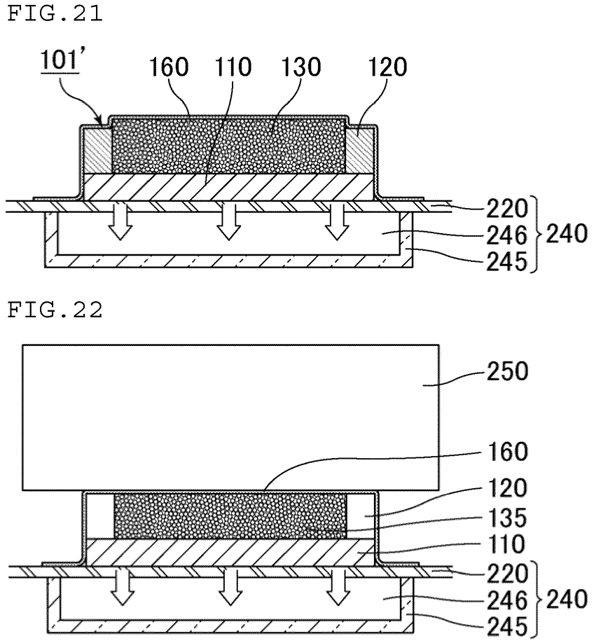

FIG. 21 is a cross sectional view with a line C-C in FIG. 18 and schematically shows an example of the fixing process (pressure reduction packaging process).

As shown in FIG. 21, in the fixing process (pressure reduction packaging process), the space sandwiched between the conveying substrate 110 and the coating film 16 is subjected to pressure reduction, and the electrode material for a lithium-ion battery is pushed from the outside by the atmospheric pressure to fix the positions of the conveying substrate 110 and the electrode material 101′ for a lithium-ion battery 1, and also the position of the electrode composition 130 is fixed by the conveying substrate 110, the frame-like member 120 and the coating film 160.

In FIG. 21, the attraction belt configuring the attraction belt conveyor 220 has a through hole (not shown) in the thickness direction, and the surface on the side of the attraction belt where the conveying substrate 110 is not placed communicates with a space 246 in a pressure reduction container 245. The space 246 in the pressure reduction container 245 is subjected to pressure reduction by a decompressor such as a vacuum pump (not shown in the figure), the space sandwiched between the conveying substrate 110 and the coating film 160 is subjected to pressure reduction through the through hole provided on the attraction belt. The arrow in FIG. 21 schematically shows the state of a gas sucked through the attraction belt. As a result, he electrode composition 130 is fixed by the conveying substrate 110, the frame-like member 120, and the coating film 160.

The combination of the attraction belt conveyor 220 and the pressure-reduced container 245 having the pressure-reduced space 246 that is provided on the opposite side of the attraction belt on which the conveying substrate 110 is placed is also the fixing section (pressure reduction packaging section) 240 constituting the manufacturing device 200 for an electrode for a lithium-ion battery electrode shown in FIG. 18.

The degree of vacuum in the space sandwiched between the conveying substrate and the coating film is preferably -50 kPa or less, more preferably -70 kPa or less, and still more preferably -80 kPa or less.

If the degree of vacuum exceeds -70 kPa, the force to fix the electrode composition is not sufficient, and the electrode composition may flow out of the frame-like member during the pressure molding process described below. More specifically, the achievable degree of vacuum in the fixing section (pressure reducing packaging section) is preferably -70 kPa or less.

The space that needs to reduce pressure in the fixing process (pressure reduction packaging process) is a small space sandwiched between the conveying substrate and the coating film. Therefore, the space sandwiched between the conveying substrate and the coating film can be subjected to pressure reduction in a shorter time than the time required to reduce pressure the entire pressurized forming device.

### Pressure Molding Process

In the pressure molding process, the electrode composition fixed by the frame-like member and the coating film in the fixing process (pressure reduction packaging process) is roll pressed. Roll pressing is performed by pressurizing the electrode composition fixed by the fixing process (pressure reduction packaging process) from the coating film side.

FIG. 22 is a cross sectional view with a line D-D in FIG. 18 and shows an example of the pressure molding process.

As shown in FIG. 22, in the pressure molding process, the roll press 250 that is the pressure molding section pressurizes the electrode composition 130 fixed by the fixing process (pressure reduction packaging process) from the side of the coating film 160 to form a pressure-molded electrode composition 135.

At this time, the electrode composition 130 is fixed by the conveying substrate 110, the frame-like member 120 and the coating film 160, so that air is not compressed during pressure molding and the moldability of electrode composition becomes excellent.

As shown in FIG. 22, it is preferable to continue pressure reduction in the space sandwiched between the conveying substrate and the coating film during the pressure molding process.

The interval between the press roller used in the roll press and the conveying substrate is preferably three times or more than the volume average particle diameter of the electrode active material particles from the viewpoint of mitigating the rise of the intense pressing force that occurs instantaneously when the roller rides up to the starting edge of the frame-like member. The interval between the press roller and the conveying substrate is preferably 20 mm or less.

In the pressure molding process, the electrode material for a lithium-ion battery may be heated.

When the conveying substrate is an electrode current collector, there is no need to separate the electrode material for a lithium-ion battery from the conveying substrate. Therefore, the frame-like member and the conveying substrate that is the electrode current collector can be bonded by heating the electrode material for a lithium-ion battery in the pressure molding process.

The heating temperature is preferably above the melting point of the resin that constitutes the frame-like member and below the temperature that would adversely affect the coating film.

### Separating Process

In the separating process, the pressure reduction of the space sandwiched between the conveying substrate and the coating film is released and the coating film is separated from the electrode material for a lithium-ion battery.

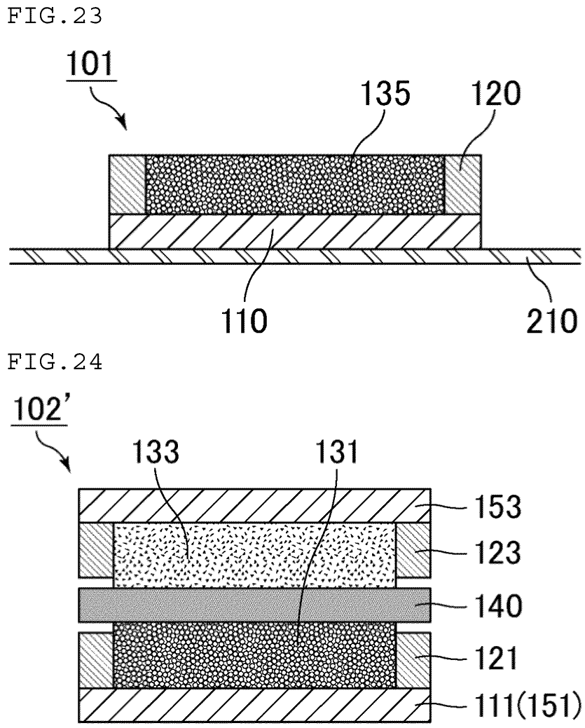

FIG. 23 is a cross sectional view with a line E-E in FIG. 18, showing immediately after the separating process.

As shown in FIGS. 17 and 18, after the pressure molding process, the electrode material 101 for a lithium-ion battery and the conveying substrate 110 move onto the belt conveyor 210, so that the pressure reduction of the space sandwiched between the conveying substrate 110 and the coating film 160 is released. The coating film 160 is then separated from the electrode material 101′ for a lithium-ion battery by the roller 260 that is the separating section, so that the electrode 101 for a lithium-ion battery consisting of the pressure-molded electrode composition 135 and the frame material 120 covering the periphery thereof can be obtained in a state of being placed on the conveying substrate 110, as shown in FIG. 23.

The electrode for a lithium-ion battery is manufactured by the above processes.

In a case of manufacturing a lithium-ion battery using the electrode for a lithium-ion battery manufactured by the above-described manufacturing method of an electrode for a lithium-ion battery, the lithium ion battery can be manufactured by, for example, connecting the electrode current collector to the electrode composition in combination with an electrode that serves as the counter electrode via a separator, adding an electrolyte to the electrode composition and the separator as needed, and then accommodating it in a battery outer package.

In a case where the substrate used in manufacturing the electrode material for a lithium-ion battery is an electrode current collector, the process of connecting the electrode current collector to the electrode composition can be omitted by not removing the substrate.

In the manufacturing method of an electrode for a lithium ion battery, a conveying substrate is a first electrode current collector, and an electrode material for a lithium ion battery preferably has the first electrode current collector; a first electrode composition including first electrode active material particles placed on the first electrode current collector; a first frame-shaped member disposed on the first electrode current collector and placed annularly to surround the first electrode composition; a separator placed on the first electrode composition and the first frame-shaped member; a second electrode composition including second electrode active material particles placed opposite the first electrode composition and the separator via the separator; and a second electrode current collector placed on the second electrode composition and the second frame-like member.

One of the first electrode active material particles and the second electrode active material particles is a positive electrode active material particle and the other is an negative electrode active material particle.

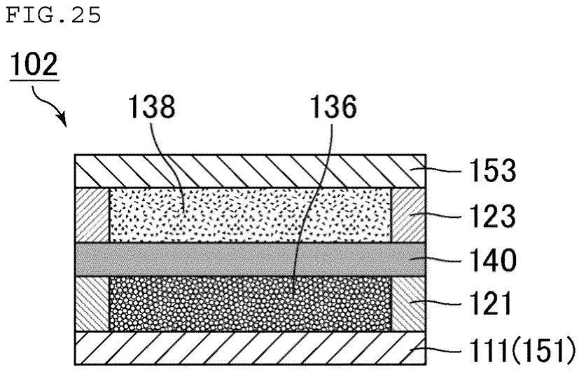

Another example of the electrode material for a lithium-ion battery will be described with reference to FIGS. 24 and 25.

FIG. 24 is a cross sectional view schematically showing another example of the electrode material for a lithium-ion battery.

The electrode material 102′ for a lithium-ion battery shown in FIG. 24 consists of a positive electrode composition 131 placed on a conveying substrate 111 that serves as a positive electrode current collector 151, a positive electrode frame-like member 121 covering the periphery of the positive electrode composition 131, a separator 140, a negative electrode composition 133 facing the positive electrode composition 131 via the separator 140, a negative electrode frame-like member 123 covering the periphery of the negative electrode composition 133, and a negative electrode current collector 153 placed on the negative electrode composition 133.

The thickness of the positive electrode composition 131 is thicker than the thickness of the positive electrode frame-shaped member 121. The thickness of the negative electrode composition 133 is thicker than the thickness of the negative electrode frame-shaped member 132. Therefore, the positive electrode frame-like member 121 does not come into contact with either the conveying substrate 111 (positive electrode current collector 151) or the separator 140. Further, the negative electrode frame-like member 123 does not come into contact with either the separator 140 or the negative electrode collector 153.

In the electrode material 102′ for a lithium-ion battery shown in FIG. 24, the separator 140 does not come into contact with the positive electrode frame-like member 121 and the negative electrode frame-like member 123. Such an electrode material for a lithium-ion battery can be obtained, for example, as follows: the positive electrode frame-shaped member 121 and the positive electrode composition 131 are placed on the conveying substrate 111 (positive electrode current collector 151) to fabricate one side (positive side) of the electrode material for a lithium-ion battery, and then the negative electrode frame-shaped member 123 and negative electrode composition 133 are placed on another substrate, and then the separator 140 is placed on one side of the first prepared electrode material for a lithium-ion battery so that the separator 140 becomes the lower side (positive electrode side).

In the lithium-ion battery electrode manufacturing device 200 shown in FIGS. 17 and 18, the electrode material 102′ for a lithium-ion battery shown in FIG. 24 is used instead of the electrode material 101′ for a lithium-ion battery. In the coating process, the electrode material 102′ for lithium-ion battery on which is the conveying substrate 111 (positive electrode current collector 152) is placed is covered with the coating film. Thus, in the fixing process (pressure reduction packaging process), the space sandwiched between the coating film and the conveying substrate 111 (positive electrode current collector 151) is subjected to pressure reduction. Therefore, the positive electrode composition 131 and the negative electrode composition 133 are fixed by the conveying substrate 111 and the coating film, and also by the positive electrode frame-like member 121 or the negative electrode frame-like member 123, respectively.

FIG. 25 is a cross sectional view schematically showing another example of the electrode for a lithium-ion battery.

In the manufacturing method shown in FIGS. 17 and 18, the electrode 102 for a lithium-ion battery shown in FIG. 25 can be obtained by using the electrode material 102′ for a lithium-ion battery shown in FIG. 24 instead of the electrode material 101′ for a lithium-ion battery.

The electrode 102 for a lithium-ion battery consists of a positive electrode current collector 151 used as the conveying substrate 111, a pressure-molded positive electrode composition 136 placed on the positive electrode current collector 151, a positive electrode frame-like member 121 covering the periphery of the pressure-formed positive electrode composition 136, a separator 140, and a separator 140, a pressure-molded negative electrode composition 138 opposite the pressure-molded negative electrode composition 136 through the separator 140, a negative electrode frame-like member 123 covering the periphery of the pressure-molded negative electrode composition 138, and a negative electrode current collector 153 placed on the pressure-molded negative electrode composition 138 and the negative electrode frame-like member 123. The pressure-molded positive electrode composition 136 and the pressure-molded negative electrode composition 138 is electrically connected to the positive electrode current collector 151 and the negative electrode current collector 153, respectively.

The processes of combining the electrode with the counter electrode and connecting the electrode current collector to the electrode composition and connecting the electrode current collector to the electrode composition can be omitted by using the 102 electrodes for a lithium-ion battery.

In the electrode material 102′ for a lithium-ion battery shown in FIGS. 24 and 25 and the electrode 102 for a lithium ion battery, the first electrode current collector is a positive electrode current collector and the first frame-like member is a positive electrode frame-like member. The second electrode current collector is the negative electrode current collector and the second frame-like member is the negative electrode frame-like member.

The positive electrode frame-like member and the negative electrode frame-like member is preferably in a substantially identical shape in plan view.

The present specification describes the following technical ideas, which are described in the basic application of this international application.

1) A manufacturing device for an electrode of a lithium-ion battery, comprising:
a placing section for placing an electrode material for a lithium-ion battery on a substrate, the electrode material for a lithium-ion battery consisting of an electrode composition including electrode active material particles and a frame-like member placed annularly so as to surround the electrode composition;
a vacuum packaging section for vacuum packaging the electrode material for a lithium-ion battery together with the substrate to obtain a vacuum package; and
a pressure molding section including a pair of rollers for roll pressing the vacuum package.

2) The manufacturing device for an electrode of a lithium-ion battery according to 1), wherein the substrate is an electrode current collector.

3) The manufacturing device for an electrode of a lithium-ion battery according to 1) or 2), wherein the interval between the pair of roller is three times or more the volume average particle size of the electrode active material particles.

4) A method for manufacturing electrode for a lithium-ion battery, comprising the steps of:
placing an electrode material for a lithium-ion battery on a substrate, the electrode material for a lithium-ion battery consisting of an electrode composition including electrode active material particles and a frame-like member placed annularly so as to surround the electrode composition;
vacuum packaging for vacuum packaging the electrode material for a lithium-ion battery together with the substrate to obtain a vacuum package; and
pressure molding for press-molding the electrode composition by roll-pressing the vacuum package by means of the pair of rollers.

5) The method for manufacturing electrode for a lithium-ion battery according to 4), wherein the substrate is an electrode current collector.

6) The method for manufacturing electrode for a lithium-ion battery according to 4) or 5), wherein the interval between the pair of roller is three times or more the volume average particle size of the electrode active material particles.

7) The method for manufacturing electrode for a lithium-ion battery according to any one of 4) to 6), wherein the average particle size of the electrode active material particles is 5 to 200 µm.

8) The method for manufacturing electrode for a lithium-ion battery according to any one of 4) to 7), wherein the degree of vacuum of the vacuum package is -70 kPa or less.

(2-1) A manufacturing device for an electrode of a lithium-ion battery, comprising:
a conveying section for conveying a conveying substrate with an electrode material for a lithium-ion battery mounted thereon, the electrode material for a lithium-ion battery consisting of an electrode composition including electrode active material particles and a frame-like member placed annularly so as to surround the electrode composition;
a coating film supplying section for covering a surface of the electrode material for a lithium-ion battery on the side opposite to a surface on which the conveying substrate is placed;
a fixing section for reducing pressure in a space sandwiched between the conveying substrate and the coating film so as to fix the electrode composition by the conveying substrate, the frame-like member and the coating film;
a pressure molding section for applying pressure to the fixed electrode composition on the side of the coating film so as to pressure-molding the electrode composition;
a separating section for releasing the pressure reduction of the space sandwiched between the conveying substrate and the coating film and also separating the coating film from the electrode material for a lithium-ion battery, wherein a process by the coating film supplying section and a process by the pressure molding section are successively carried out while conveying the conveying substrate by the conveying section.

2) The manufacturing device for an electrode for a lithium-ion battery according to 1), wherein the conveying substrate is an electrode current collector.

3) The manufacturing device for an electrode of a lithium-ion battery according to 1), wherein the conveying substrate is an attraction belt, and

the fixing section reduced pressure in the space sandwiched between the attraction belt and the coating film through a through-hole formed on the attraction belt.

4) The manufacturing device for an electrode for a lithium-ion battery according to any of 1) to 3), wherein the pressure molding section is a roll press.

5) A manufacturing method for an electrode of a lithium-ion battery, comprising the steps of:
conveying a conveying substrate with an electrode material for a lithium-ion battery mounted thereon, the electrode material for a lithium-ion battery consisting of an electrode composition including electrode active material particles and a frame-like member placed annularly so as to surround the electrode composition;
overing a surface of the electrode material for a lithium-ion battery on the side opposite to a surface on which the conveying substrate is placed;
reducing pressure in a space sandwiched between the conveying substrate and the coating film so as to fix the electrode composition by the conveying substrate, the frame-like member and the coating film;
applying pressure to the fixed electrode composition on the side of the coating film so as to pressure-molding the electrode composition;
releasing the pressure reduction of the space sandwiched between the conveying substrate and the coating film and also separating the coating film from the electrode material for a lithium-ion battery, wherein a process by the coating film supplying section and a process by the pressure molding section are successively carried out while conveying the conveying substrate by the conveying section.

6) The manufacturing method for electrode for a lithium-ion battery according to ), wherein the conveying substrate is an electrode current collector.

7) The manufacturing method for an electrode of a lithium-ion battery according to 5), wherein the conveying substrate is an attraction belt, and

in the fixing process, pressure in the space sandwiched between the attraction belt and the coating film is reduced through a through-hole formed on the attraction belt.

8) The manufacturing method for an electrode of a lithium-ion battery according to any of 5) to 7), wherein the degree of vacuum in the space sandwiched between the conveying substrate and the coating film in the fixing process is -70 kPa or less.

9) The manufacturing method for an electrode of a lithium-ion battery according to any of 5) to 8), wherein, in the pressure molding process, the fixed electrode composition is pressurized using a roll press.

10) The average particle diameter of the electrode active material particles is 5 to 200 µm. (2-10) The method for producing electrodes for a lithium-ion battery according to any of (2-5) to (2-9) above, wherein the average particle size of the electrode active material particles is 5 to 200 µm.

11) The manufacturing method for an electrode of a lithium-ion battery according to 6), wherein the conveying substrate is a first electrode current collector, and

the electrode material for a lithium ion battery preferably has the first electrode current collector; a first electrode composition including first electrode active material particles placed on the first electrode current collector; a first frame-shaped member disposed on the first electrode current collector and placed annularly to surround the first electrode composition; a separator placed on the first electrode composition and the first frame-shaped member; a second electrode composition including second electrode active material particles placed opposite the first electrode composition and the separator via the separator; and a second electrode current collector placed on the second electrode composition and the second frame-like member.

### INDUSTRIAL APPLICABILITY

The manufacturing method for an electrode for a lithium-ion battery and the manufacturing device therefor are particularly useful as a method for manufacturing an electrode for a lithium-ion battery used in cell phones, personal computers, hybrid and electric vehicles, and the manufacturing device thereof.

### REFERENCE SIGNS LIST

1 electrode for a lithium-ion battery
1′, 2′, 3′ electrode material for a lithium-ion battery
5 vacuum package (electrode composition fixed by the frame-like member and the packaging material)
10, 11 substrate
20 frame-like member
21 positive electrode frame-like member
23 negative electrode frame-like member
30 electrode composition
31 positive electrode composition
33 negative electrode composition
35 molded electrode composition
40 packaging material
41 opening
50 press roll
60 separator
71 positive electrode current collector
73 negative electrode current collector
101, 102 electrode for a lithium-ion battery
101′, 102′ electrode material for a lithium-ion battery
110, 111 conveying substrate
120 frame-like member
121 positive electrode frame-like member
123 negative electrode frame-like member
130 electrode composition
131 positive electrode composition
133 negative electrode composition
135 pressure-molded electrode composition
136 pressure-molded positive electrode composition
138 pressure-molded negative electrode composition
140 separator
151 positive electrode current collector
153 negative electrode current collector
160 coating film
200 manufacturing device for an electrode of a lithium-ion battery
210 first conveying section (belt conveyer)
220 second conveying section (attraction belt conveyer)
230 coating film supplying section (roller)
240 fixing section (pressure reduction packaging section )
245 pressure reducing container
246 space
250 pressure molding section (roll press)
260 separating section (roller)

1. A manufacturing device for an electrode of a lithium-ion battery, comprising:
a placing section for placing an electrode material for a lithium-ion battery on a substrate, the electrode material for a lithium-ion battery consisting of an electrode composition including electrode active material particles and a frame-like member placed annularly so as to surround the electrode composition;
a pressure reduction packaging section for reducing pressure and packaging the electrode material for a lithium-ion battery together with the substrate so as to fix the electrode composition by the frame-like member and a packaging material; and
a pressure molding section for roll-pressing the electrode composition fixed by the frame-like member and the packaging material.

2. The manufacturing device for an electrode of a lithium-ion battery according to claim 1, wherein the substrate is an electrode current collector.

3. The manufacturing device for an electrode of a lithium-ion battery according to claim 1, wherein the pressure molding section includes a pair of roller, and the interval between the pair of roller is three times or more the volume average particle size of the electrode active material particles.

4. A method for manufacturing electrode for a lithium-ion battery, comprising the steps of:
placing an electrode material for a lithium-ion battery on a substrate, the electrode material for a lithium-ion battery consisting of an electrode composition including electrode active material particles and a frame-like member placed annularly so as to surround the electrode composition;
pressure reduction packaging for reducing pressure and packaging the electrode material for a lithium-ion battery together with the substrate to fix the electrode composition by the frame-like member ana a packaging material; and
pressure molding the electrode composition by roll-pressing the electrode composition fixed by the frame-like member and the packaging material.

5. The method for manufacturing electrode for a lithium-ion battery according to claim 4, wherein the substrate is an electrode current collector.

6. The method for manufacturing electrode for a lithium-ion battery according to claim 4, wherein the pressure molding section includes a pair of roller, and the interval between the pair of roller is three times or more the volume average particle size of the electrode active material particles.

7. The method for manufacturing electrode for a lithium-ion battery according to claim 4, wherein the average particle size of the electrode active material particles is 5 to 200 µm.

8. The method for manufacturing electrode for a lithium-ion battery according to claim 4, wherein the degree of vacuum of the electrode composition fixed by the frame-like member and the packaging material is -70 kPa or less.

9. A manufacturing device for an electrode of a lithium-ion battery, comprising:
a conveying section for conveying a conveying substrate with an electrode material for a lithium-ion battery mounted thereon, the electrode material for a lithium-ion battery consisting of an electrode composition including electrode active material particles and a frame-like member placed annularly so as to surround the electrode composition;
a coating film supplying section for covering a surface of the electrode material for a lithium-ion battery on the side opposite to a surface on which the conveying substrate is placed;
a pressure reduction packaging section for reducing pressure in a space sandwiched between the conveying substrate and the coating film so as to fix the electrode composition placed on the conveying substrate by the frame-like member and a packaging material; and
a pressure molding section for roll-pressing the electrode composition fixed by the frame-like member and the packaging material.

10. The manufacturing device for an electrode of a lithium-ion battery according to claim 9, comprising a separating section for releasing the pressure reduction of the space sandwiched between the conveying substrate and the coating film and also separating the coating film from the electrode material for a lithium-ion battery.

11. The manufacturing device for an electrode of a lithium-ion battery according to claim 9, wherein a process by the coating film supplying section and a process by the pressure molding section are successively carried out while conveying the conveying substrate by the conveying section.

12. The manufacturing device for an electrode of a lithium-ion battery according to claim 9, wherein the conveying substrate is an attraction belt, and
the pressure reduction packaging section reduced pressure in the space sandwiched between the attraction belt and the coating film through a through-hole formed on the attraction belt.
